(19) United States
(12) Patent Application Publication
(10) Pub. No.: US 2008/0192963 A1
(43) Pub. Date: Aug. 14, 2008

(54) Condenser microphone

(75) Inventor: Akiyoshi Sato, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/069,307

(22) Filed: Feb. 8, 2008

(30) Foreign Application Priority Data
Feb. 9, 2007 (JP) 2007-031377
Feb. 9, 2007 (JP) 2007-031378
Mar. 9, 2007 (JP) 2007-059543

(51) Int. Cl. H04R 9/08

(52) U.S. Cl. 381/174

(57) ABSTRACT

A condenser microphone 14 and an accelerometer 16 are placed on a device substrate 12 with arranging same sides in a same direction. Both condenser microphone 14 and accelerometer 16 are formed of condenser microphones. Sizes of the condenser microphone 14 and accelerometer 16 are same other than diameters of back cavities 20 and 120. A step 40 that decreases an inner diameter of the back cavity 20 is formed inside the back cavity 20 to function as an audio resistance, whereas the back cavity 120 of the accelerometer 16 has no step (audio resistance). A microphone output is obtained by subtracting a terminal voltage of the condenser microphone 14 by a terminal voltage of the accelerometer 16.

### CROSS REFERENCE TO RELATED APPLICATION

This application is based on Japanese Patent Application 2007-031377, filed on Feb. 9, 2007, Japanese Patent Application 2007-031378, filed on Feb. 9, 2007, and Japanese Patent Application 2007-059543, filed on Mar. 9, 2007, the entire contents of which are incorporated herein by reference.

### BACKGROUND OF THE INVENTION

A) Field of the Invention

This invention relates to a condenser microphone including an electret condenser microphone and more specifically to a condenser microphone that can restrain generation of noise caused by an impact of something on the condenser microphone.

B) Description of the Related Art

When a user mistakenly makes an impact on a microphone with something, the impact oscillates a diaphragm of the microphone so that the microphone generates (or picks up) an unnecessary impact sound. Japanese Laid-open Patent No. 2001-36607 discloses a technique for restraining generation of that kind of an impact sound. In the disclosed technique, a receiver/transmitter of a telephone or a radio device is equipped with first and second microphone elements, wherein sensitivity of the first microphone element is set lower than that of the second microphone element by masking a sound pick-up of the first microphone element with a resin sheet, and sensitivities of both microphone elements toward an impact are made to be equal for cancelling output signals with each other by a calculation process. By this technique, the calculation process does not cancel a voice sound very much because the sensitivities of both microphone elements are very much different but cancels an impact sound because both microphone elements pick up the impact sound at the same level. As a result, it will be highly sensitive to a voice sound and also can restrain an impact sound because of low sensitivity to an impact sound.

The above-described conventional technique requires masking of a pick-up part of a microphone element with a resin sheet, and so it will increase number of steps in a manufacturing process and may raise a cost for manufacturing.

### SUMMARY OF THE INVENTION

It is an object of the present invention to provide a condenser microphone that can restrain an impact sound without masking.

It is an object of the present invention to provide a condenser microphone that needs no calculation process for output signals of microphone elements.

According to one aspect of the present invention, there is provided a condenser microphone, comprising: a first condenser type element having a diaphragm and a back plate which opposes to each other via a space; a second condenser type element having a diaphragm and a back plate which opposes to each other via a space; a subtraction device that subtracts a terminal voltage of the second condenser type element from a terminal voltage of the first condenser type element; and an output device that outputs an output of the subtraction device as a microphone output, and wherein same planes of the first and the second condenser type elements are arranged in a same direction, and the second condenser type element has a larger ratio of an amount of sound waves picked up on a surface of the diaphragm to an amount of sound waves passing around and picked up on a back of the diaphragm than that of the first condenser type element.

According to the present invention, the ratio of an amount of sound waves picked up on the surface of the diaphragm to an amount of sound waves passing around and picked up on the back of the diaphragm is small in the first condenser type element and large in the second condenser type element. An amount of sound waves on the surface and the back of the diaphragm that are cancelled with each other is small in the first condenser type element whereas an amount of sound waves on the surface and the back of the diaphragm that are cancelled with each other is large in the second condenser type element. As a result, the first condenser type element has high sensitivity to sound waves while the second condenser type element has relatively lower sensitivity to the sound waves than the first condenser type element so that an output corresponding to the sound waves can be obtained sufficiently to function as a microphone even if the terminal voltage of the first condenser type element is subtracted by the terminal voltage of the second condenser type element. On the other hand, regarding to an impact sound, the diaphragms of both condenser type elements oscillate in the same manner and the sensitivities will be the same because the same surfaces of both condenser type elements are arranged in the same direction. Therefore, the impact sound is cancelled by subtracting the terminal voltage of the first condenser type element by that of the second condenser type element, and an output level of the impact sound will be low. By that structure, generation of an impact sound can be restrained without masking a pick-up part of a condenser type element.

Moreover, the subtraction device may subtract the terminal voltage of the second condenser type element from the terminal voltage of the first condenser type element after making the terminal voltage of the second condenser type element pass through a low-pass filter. That is, when the second condenser type element is highly sensitive to a high frequency band of sound waves, the high frequency band of the microphone output is attenuated by the subtraction. The attenuation of the high frequency band of the microphone output can be restrained by cutting the high frequency band of the terminal voltage of the second condenser type element with the low-pass filter.

In the condenser microphone according to the present invention may be formed with the following features. Each of the first and the second condenser type elements comprises a base part having a back cavity, one side of which is covered by the diaphragm of the first or the second condenser type element and another side of which is closed, each of the diaphragms of the first and the second condenser type elements is supported by one surface of each base part and has a pierced hole on a peripheral rim to pass a sound wave to each back cavity, each of the back plates of the first and the second condenser type elements has a pierced hole thorough which the sound wave passes on its surface and is supported by one surface of each base part to be arranged above each diaphragm via the space, the back cavity of the first condenser type element has an audio resistance formed with a step formed in an intermediate part in an axis direction to make an inner diameter of a part close to the diaphragm larger than a part far from the diaphragm, and the back cavity of the second condenser type element has an audio resistance that is smaller than the audio resistance formed in the back cavity of the first condenser type element or has no audio resistance.

By the above-described features, the back cavity of the first condenser type element has the audio resistance consisting of the step of which inner diameter is large at the point near the diaphragm and small at the point far from the diaphragm is formed at an intermediate position in the axis direction; therefore, an amount of sound waves passing thorough the pierced hole on the peripheral rim of the diaphragm to the back of the diaphragm and received on the back can be reduced. On the other hand, the back cavity of the second condenser type element has the audio resistance consisting of smaller step than that of the first condenser type element or has no audio resistance; therefore, an amount of sound waves passing thorough the pierced hole on the peripheral rim of the diaphragm to the back of the diaphragm and received on the back can be increased. By that, sensitivity of the first condenser type element to sound waves will be high while sensitivity of the second condenser type element will be low.

In the condenser microphone according to the present invention, the diaphragm of the second condenser type element may have a pierced hole to make a part of sound waves impacted on a surface of the diaphragm pass through to a back of the diaphragm, whereas the diaphragm of the first condenser type element has no pierced hole on a surface. By that, the amount of the sound waves rounding to the back of the diaphragm through the pierced hole is increased; therefore, the sensitivity of the diaphragm of the second condenser type element will be decreased comparing to a case when the diaphragm has no pierced hole on its surface. Therefore, an amount of attenuation of the sound waves by the subtraction is reduced comparing to the case when the diaphragm has no pierced hole on its surface, and the sensitivity to a voice sound of the condenser microphone as a whole will increase.

In the condenser microphone according to the present invention, a diameter of a main part of the back cavity of the first condenser type element may be smaller than a diameter of a main part of the back cavity of the first condenser type element while sizes of other parts are same. The first and the second condenser type elements are formed in the same size other than the diameters of the back cavities so that sensitivities to an impact sound will be similar to each other. Therefore, the terminal voltages of both condenser type elements can be cancelled precisely by the subtraction, and generation of the impact sound can be effectively restrained.

In the condenser microphone according to the present invention, difference of sensitivities to an impact sound between the diaphragms of the first and the second condenser type elements is preferably the same; however, the difference may be within 3 dB or more preferably within 1 dB.

According to another aspect of the present invention, there is provided a condenser microphone, comprising: a first condenser type element having a diaphragm and a back plate which oppose to each other via a space; a second condenser type element having a diaphragm and a back plate which oppose to each other via a space and a same property as the first condenser element; a first wiring that electrically connects the diaphragm of the first condenser type element with the diaphragm of the second condenser type element; and a second wiring that electrically connects the back plate of the first condenser type element with the back plate of the second condenser type element, wherein the first and the second condenser type elements are configured by facing the diaphragms or the back plates.

According to the present invention, the diaphragms of the condenser microphone elements displace in the same phase in accordance with a sound and displace in the opposite phases to an impact to the back plates. Therefore, capacity changes of the condenser microphone elements are generated in the same phase to the sound, and capacity changes of the condenser microphone elements as a whole condenser microphone will be larger than that of one condenser microphone element. On the other hand, capacity changes of the condenser microphone elements are generated in the different phases to the impact, and capacity changes of the condenser microphone elements as a whole condenser microphone will be smaller than that of one condenser microphone element. By that, a condenser microphone with a good sensitivity to a sound and a low sensitivity to an impact can be realized. Therefore, a impact sound is hardly generated even though a user mistakenly makes an impact on a microphone with something. Therefore, a calculation process for cancelling an oscillation sound picked up by the condenser microphone elements becomes unnecessary.

In the above-described condenser microphone, each of the first and the second condenser type elements may comprise a substrate having a back cavity, one side of which is covered by the diaphragm of the first or the second condenser type element, each of the back plates of the first and the second condenser type elements may have a pierced hole to pass a sound wave from outside, each of the diaphragms of the first and the second condenser type elements may have a pierced hole thorough which connects the back cavity to an open air via the pierced hole of the back cavity, and each of the back cavity of the first and the second condenser type elements may have an audio resistance formed with a step formed in an intermediate part in an axis direction to make an inner diameter of a part close to the diaphragm larger than a part far from the diaphragm. Although the pierced hole is formed in the peripheral rim of each diaphragm, sound waves are objected to pass through the back cavity via the pierced hole in the peripheral rim because of the existence of the audio resistance (step). Therefore, each diaphragm can sufficiently oscillate in accordance with a sound, and sufficient sensitivity can be obtained.

According to a further aspect of the present invention, there is provided a condenser microphone, comprising: a first condenser type element having a diaphragm and a back plate which oppose to each other via a space; a second condenser type element having a diaphragm and sharing the back plate with the first condenser type element, the diaphragm and the shared back plate opposing to each other via a space; and a wiring that electrically connects the diaphragm of the first condenser type element with the diaphragm of the second condenser type element.

In the above-described condenser microphone, two condenser type microphone elements are configured by facing opposite sides; therefore, generation of an impact sound will be restrained when the condenser microphone is hit by something. Moreover, because the back plate is commonly used by two condenser type microphone elements, structures of the condenser type microphone elements will be simple comparing to that each condenser type microphone element has its own back plate.

According to still another aspect of the present invention, there is provided a condenser microphone, comprising: a first condenser type element having a diaphragm and a back plate which oppose to each other via a space; a second condenser type element having a diaphragm and a back plate which oppose to each other via a space and a same property as the first condenser element; a package in which the first and the second condensers are placed with facing same planes in a same direction; and an audio hole that is formed at a position of the package corresponding to a sound wave irradiating surface of the first condenser type element, takes in a sound wave from outside and is acoustically closed by the first condenser type element, wherein a sound wave is taken into the package from the audio hole and oscillates the diaphragm of the first condenser type element, and a sound wave generated by the oscillation of the diaphragm of the first condenser type element is transmitted inside a space of the package and oscillates the diaphragm of the second condenser type element.

In the above-described condenser microphone, sound waves from outside enters from the audio hole of the package and oscillate the diaphragm of the first condenser type element, and the sound waves generated by the oscillation of the diaphragm passes through the internal space of the package and oscillate the second condenser type element. Therefore, irradiating directions of the sound of the first and second condenser type elements in accordance with a sound from outside are opposite to each other. That is, the diaphragms of the first and second condenser type elements displace in correspondence with a sound from outside in different phases from each other. On the other hand, because same planes of the first and the second condenser type elements are arranged in a same direction, the diaphragms of both condenser type elements displace in the same direction with inertia by the impact when the impact is given to the condenser microphone from outside. Therefore, when subtraction of both output signals of the first and second condenser elements is performed, the condenser microphone with low sensitivity to the impact can be realized. Therefore, an impact sound is hardly generated even though a user mistakenly makes an impact on a microphone with something. By that structure, generation of an impact sound can be restrained without masking a pick-up part of a condenser type element.

The above-described condenser microphone may further comprises impedance converters in the package for the first and the second condenser type elements, and a subtraction device that subtracts outputs signals of the impedance converters with each other and outputs the subtracted signal to an external device.

The above-described condenser microphone may further comprises impedance converters in the package for the first and the second condenser type elements and individually output the converted signals to an external device. By doing that, the condenser microphone will be a balanced-output type, and a noise from outside can be removed by subtracting the signals on both output signal lines by a following circuit even though the noise is generated on the output signal lines of both outputs.

In the condenser microphone according to the present invention, wherein the first and the second condenser type elements may be formed of micro electro mechanical systems (MEMS) devices.

### BRIEF DESCRIPTION OF THE DRAWINGS

FIG. 1 is a cross sectional view of a condenser microphone 10 cut in a longitudinal direction according to a first embodiment of the present invention.

FIG. 2 is a decomposition perspective view of the condenser microphone 10.

FIG. 3 is a plan view of a condenser microphone element 14 in FIG. 1 from a back plate 32.

FIG. 4 is a circuit diagram of the condenser microphone 10 in FIG. 1.

FIG. 5 is a diagram showing definitions of measurements a to d of each part of the condensers 14 and 16 in FIG. 1.

FIG. 6 is a graph showing an output frequency property of a sound when a width “d” of the slit in FIG. 5 equals 50 μm.

FIG. 7 is a graph showing an output frequency property of a sound when a width “d” of the slit in FIG. 5 equals 5 μm.

FIG. 8 is a graph showing an output frequency property of a sound when a width “d” of the slit in FIG. 5 equals 1 μm.

FIG. 9 is a graph showing an output frequency property of a sound when a width “d” of the slit in FIG. 5 equals 0.5 μm.

FIG. 10A and FIG. 10B are diagrams showing an example of structure of an acceleration sensor element 16 of the condenser microphone according to the second embodiment of the present invention. FIG. 10A is a cross sectional view as viewed at positions of arrows C-C in FIG. 10B, and FIG. 10B is a cross sectional view as viewed at positions of arrows B-B in FIG. 10A.

FIG. 11 is a cross sectional view of a condenser microphone cut in a longitudinal direction according to a third embodiment of the present invention.

FIG. 12 is a decomposition perspective view of the microphone assembly in FIG. 11.

FIG. 13 is a plan view of the condenser microphone element 512 in FIG. 11 from a back plate 526.

FIG. 14 is a plan view of the condenser microphone element 514 in FIG. 11 from a back plate 626.

FIG. 15 is a circuit diagram of the microphone assembly in FIG. 11.

FIG. 16A to FIG. 16C are pattern diagrams showing relationships between capacities of the condenser microphone elements 512 and 514 and differences between movements of the diaphragms 520 and 620 of the condenser microphone 510 when sound waves by a sound from outside are transmitted to an apparatus mounting the microphone assembly in FIG. 11 and when an impact is given from outside such as hitting the apparatus to something.

FIG. 17 is a cross sectional view of a condenser microphone cut in a longitudinal direction according to a fourth embodiment of the present invention.

FIG. 18 is a decomposition perspective view of the microphone assembly in FIG. 17.

FIG. 19 is a plan view of the condenser microphone element 212 in FIG. 17 from a back plate 226.

FIG. 20 is a plan view of the condenser microphone element 214 in FIG. 17 from a back plate 326.

FIG. 21 is a cross sectional view of a condenser microphone out in a longitudinal direction according to a fifth embodiment of the present invention.

FIG. 22 is a decomposition perspective view of the microphone assembly in FIG. 21.

FIG. 23 is a circuit diagram of the microphone assembly in FIG. 21.

FIG. 24A to FIG. 24C are diagrams showing a sixth embodiment of a condenser microphone according to sixth embodiment of the present invention.

FIG. 25 is a pattern diagram showing an operation of the condenser microphone 10 when sound waves are input from outside to the condenser microphone 10.

FIG. 26A is a graph showing a waveform of output signal of the condenser microphone element 712, and FIG. 268 is a graph showing a waveform of output signal of the condenser microphone element 714 according to the operation shown in FIG. 25.

FIG. 27 is a pattern diagram showing an operation of the condenser microphone 10 when an impact is given to the condenser microphone 10 from outside.

FIG. 28A is a graph showing a waveform of output signal of the condenser microphone element 712, and FIG. 28B is a graph showing a waveform of output signal of the condenser microphone element 714 according to the operation shown in FIG. 27.

FIG. 29 is a schematic circuit diagram of the condenser microphone 10 according to the sixth embodiment of the present invention.

FIG. 30 is a schematic circuit diagram of the condenser microphone 10 according to a seventh embodiment of the present invention.

### DETAILED DESCRIPTION OF THE PREFERRED EMBODIMENTS

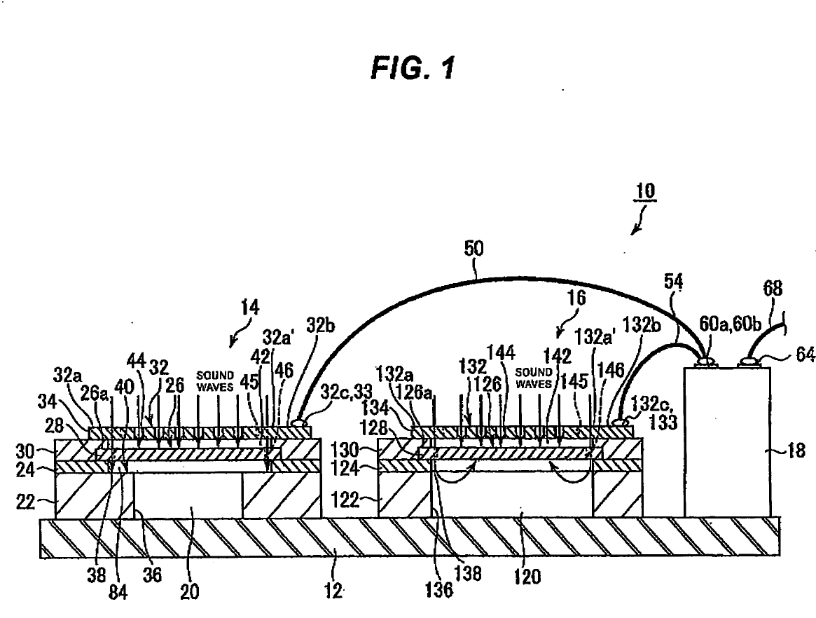

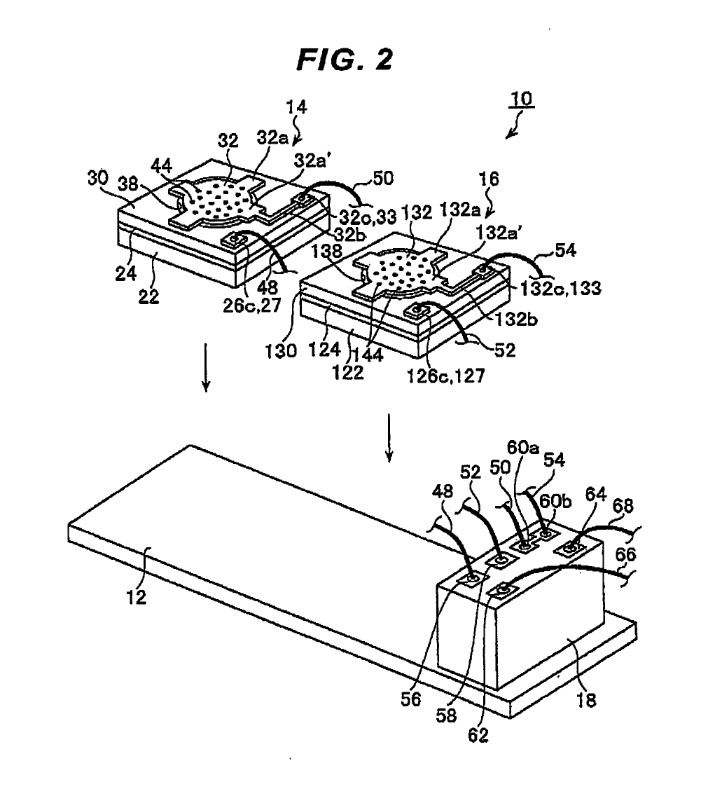

FIG. 1 is a cross sectional view of a condenser microphone 10 cut in a longitudinal direction according to a first embodiment of the present invention. FIG. 2 is a decomposition perspective view of the condenser microphone 10.

As shown in FIG. 1, the condenser microphone 10 consists of a is device substrate 12 on which a condenser microphone element (a first condenser type element) 14, an acceleration sensor element (a second condenser type element) 16 and a LSI18 for impedance conversion are mounted by mutually being insulated with each another and fixed with adhesive. Both of the condenser type elements 14 and 16 are composed of condenser-typed elements and are positioned on the substrate 12 with the same surfaces facing a same direction. Opening ends of back cavities 20 and 120 of both elements 14 and 16 are sealed with the substrate 12. Both elements 14 and 16 are composed of the same measurement other than a diameter of opening parts 36 and 136 (explained later) composing main parts of the back cavities 20 and 120 (diameter of the opening part 36<diameter of the opening part 136). Moreover, same parts of the elements 14 and 16 are formed with the same materials. Therefore, inertia moment of diaphragms 26 and 126 described later is same as each other. Moreover, the difference in inertia moment (difference of sensitivities to the impact) may be within 3 dB or more preferably within 1 dB. The both elements 14 and 16 are composed by using the MEMS process. Moreover, the both elements 14 and 16 may be composed by assembling individual parts in a case of a relatively large condenser microphone.

First, the condenser microphone element 14 will be explained. The condenser microphone element 14 is formed by forming an insulating layer 24 by silica film on a surface of a substrate 22 composed of silicon and the like and thereon forming a conductive film 28 composing a diaphragm (oscillating plate) 26, an insulating layer 30 made of silica film and the like and a conductive film 34 composing a back plates (back electrode plate, fixing electrode) 32 in sequence with a semiconductor manufacturing process. An opening part (pierced hole) 36 having a circular cross section is formed in the center of the substrate 22. An opening part (pierced hole) 38 having circular cross section is formed in communication with the opening part 36 in the center parts of the insulating layers 24 and 30 in a same axis as the opening part 36 of the substrate 22. A diameter of the opening part 36 of the substrate 22 is smaller than that of the opening parts 38 of the insulating layers 24 and 30, and a step 40 is formed at a border part.

The opening part 36 of the substrate 22 forms a back cavity (back air chamber) 20. A space 42 with a fixed length is formed between the back plate 32 and the diaphragm 26. Plurality of pierced holes 44 are formed on the back plate 32. Sound waves by a sound generated outside enter to the space 42 from those pierced holes 44 and hit on the surface of the diaphragm 26 to drive the diaphragm 26. A pierced hole 46 with narrow width for pressure adjustment is formed on a peripheral rim of the diaphragm 26 to pass the sound waves to the back cavity 20. Since the diameter of the opening part 36 of the substrate 22 is formed smaller than that of the opening parts 38 of the insulating layers 24 and 30, audio resistance is large at the step 40 at the border part of both of the openings 36 and 38, the sound waves hardly pass thorough the pierced hole 46 for pressure adjustment to the back of the diaphragm 26. Therefore, an amount of sound waves to be cancelled on the front and back surfaces of the diaphragm 26 to sound is small, and high sensitivity can be obtained.

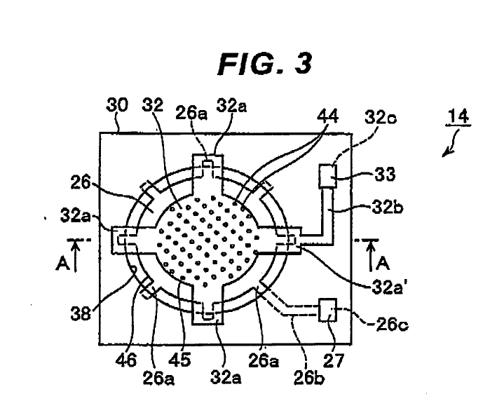

FIG. 3 is a plan view of the condenser microphone element 14 in FIG. 1 from the back plate 32. A structure of the cross section of the condenser microphone element 14 shown in FIG. 1 is equivalent to the cross section as viewed at positions of arrows A-A in FIG. 3. As shown in FIG. 3, a plan shape of the diaphragm 28 is formed in a circular shape with slightly smaller diameter than the opening parts 38, and a supporting part 26a projecting to outside is formed and arranged at the peripheral rim at equiangular intervals. The diaphragm 26 is positioned in concentric to the opening parts 38 and fixed and supported on the insulating layer 24 by the supporting parts 26a. By that, the pierced hole 46 with narrow width for pressure adjustment is formed between the opening parts 38 and the peripheral rim of the diaphragm 26. One (26a′) of the supporting parts 26a is extended to compose a lead wire 26b. An end of the lead wire 26b pierces through the insulating layer 30 and reaches to the surface of the insulating layer 30 to compose a terminal base 26c.

As shown in FIG. 3, the back plate 32 is formed in a smaller circular shape than that of the diaphragm 26, and supporting parts 32a projecting outside are formed and arranged at the peripheral rim. The back plate 32 is positioned and fixed in concentric to the opening parts 38 and supported on the insulating layer 30 by the supporting parts 32a. By that, a pierced hole 45 with wide width is formed between the opening parts 38 and the peripheral rim of the back plate 32. Sound waves enters to the space 42 via the pierced hole 44 formed inside this pierced hole 45 and the back plate 32 to drive the diaphragm 26. One (32a′) of the supporting parts 32a is extended to compose a lead wire 32b. An end of the lead wire 32b composes a terminal base 32c on the insulating layer 30.

An example of manufacturing process of the condenser microphone 14 by the micro electro mechanical systems (MEMS; a semiconductor manufacturing) process will be explained.

(1) The insulating layer 24 and the conductive film 28 are formed in sequence on the substrate 22 in which the opening 36 has not been formed yet.

(2) The conductive film 28 is patterned by a photolithography technique, and the supporting parts 26a, 26a′, and the lead wire 26b (FIG. 3) which are connecting to the diaphragm 26 and the conductive film 28 are formed.

(3) An insulating layer 30 is formed.

(4) The pierced hole through the lead wire 26b is formed at a part of the insulating layer 30 by etching.

(5) The conductive film 34 is formed on the insulating layer 30. At this time, the conductive films are deposited also in the above-described pierced hole of the insulating layer 30 and are connected with the lead wire 26b to be conductive.

(6) The conductive film 34 is patterned by photolithography, and the supporting parts 32a, 32a′, the lead wire 32b and the terminal base 32c which are connecting with the back plate 32 and the conductive film 34 are formed. At this time, the pierced hole 44 is formed on the back plate 32 simultaneously. Moreover, the terminal base 26c connecting with the lead wire 26b of the diaphragm 26 is also formed.

(7) Aluminum film and the like are formed by sputtering as covering at least a region where terminals 27 and 33 will be formed, and the terminal 27 that is conductive to the terminal base 26c and the terminal 33 that is conductive to the terminal base 32c are respectively formed.

(8) The back surface of the substrate 22 is etched until the insulating layer 24 is exposed, and thereafter the opening part 36 is formed.

(9) The center parts of the insulating layer 24 and 30 are selectively etched and removed from both of the front and back surfaces of the substrate 22 by using etching liquid such as fluorinated acid and the like. That is, the etching liquid enters from the opening part 36 to the back side, and the center part of the insulating layer 24 is etched and removed to form opening parts 38. Moreover, the etching liquid enters from the pierced holes 44 and 45 to the front side, and the center part of the insulating layer 30 is etched and removed to form a space 42. The pierced holes are formed by etching, and the opening parts 36 and 38 are connected to each other.

As described in the above, the condenser microphone 14 is formed.

On the other hand, the acceleration sensor element 16 has the same structure as the condenser microphone element 14 other than that the diameter of the back cavity 120 is formed larger than the diameter of the back cavity 20. In the acceleration sensor element 16, the same components as in the condenser microphone are represented by the reference numbers added with 100 to those representing the components of the condenser microphone 14, and explanations for those same components will be omitted. An opening part 136 of the substrate 122 is formed with the same diameter as the opening parts 138 of the insulating layers 128 and 130. Therefore, a step corresponding to the step 40 formed in the condenser microphone element 14 does not exist in the acceleration sensor element 16. By that, audio resistance does not increase at the border parts of the opening parts 136 and 138. Therefore, sound waves tend to pass through a pierced hole 146 for pressure adjustment to the back of the diaphragm 126. Therefore, an amount of sound waves to cancel on both of the front and back surfaces of the diaphragm 126 to the sound is large, and sensitivities will become low.

Moreover, it is not necessary that the diameters of the opening parts 136 and 138 are completely same, and the opening part 136 may be formed slightly smaller than the opening part 138 so that a small step may be formed at the border part of the opening parts 136 and 138. Moreover, a plane structure of the acceleration sensor element 16 is same as the structure in FIG. 3 showing the condenser microphone element 14. Moreover, the acceleration sensor element 16 can be manufactured by the same method as that of the above-described condenser microphone element 14. Both of the elements 14 and 16 can be formed on a same wafer simultaneously.

According to the above-described condenser microphone element 14 and the acceleration element 16, sensitivity of the condenser microphone element 14 is relatively high, and sensitivity of the acceleration sensor element 16 is relatively low. Regarding to the sound wave of a voice from outside, as described in the above, sensitivity of the condenser microphone element 14 is relatively higher than the acceleration sensor element 16 and sensitivity of the acceleration sensor element 16 is relatively lower than the condenser microphone element 14 because diameters of opening parts 36 and 136 forming the back cavities 20 and 120 are different (in other words, existence of the step 40 or sizes of the steps 40 are different) and thereby amounts of sound waves rounding to the backs of the diaphragms 26 and 126 are different. Moreover, since the same surfaces of the condenser microphone element 14 and the acceleration sensor element 16 are positioned toward the same direction, the diaphragms 26 and 126 of both of the elements 14 and 16 oscillate equally to the impact with inertia by the impact. Therefore, sensitivities become equal.

Wirings in the condenser microphone 10 mounting the condenser microphone element 14, the acceleration sensor element 16 and the LSI18 for impedance conversion on the substrate 12 as described in the above will be explained. As shown in FIG. 2, an end of a lead wire 48 is connected with the terminal 27 of the diaphragm 26 of the condenser microphone element 14 by soldering. Another end of the lead wire 48 is connected with a terminal 56 of the LSI18 for impedance conversion by soldering. An end of a lead wire 50 is connected with the terminal 33 of the back plate 32 of the condenser microphone element 14 by soldering. Another end of the lead wire 50 is connected with a terminal 60a of the LSI18 for impedance conversion by soldering. An end of a lead wire 52 is connected with a terminal 127 of the diaphragm 126 of the acceleration sensor element 16 by soldering. Another end of the lead wire 52 is connected with a terminal 58 of the LSI18 for impedance conversion by soldering. An end of a lead wire 54 is connected with a terminal 133 of a back plate 132 of the acceleration sensor element 16 by soldering. Another end of the lead wire 54 is connected with a terminal 60b (the terminals 60a and 60b are connected) of the LSI18 for impedance conversion by soldering. Lead wires 66 and 68 are respectively connected with terminals 62 and 64 of the LSI18 for impedance conversion. The condenser microphone 10 with the above-described structure is used in various microphone devices (microphone for stages, microphone for studios and the like) and various devices such as a receiver/transmitter of a telephone or a radio device, cellular phone, sound recorder and the like.

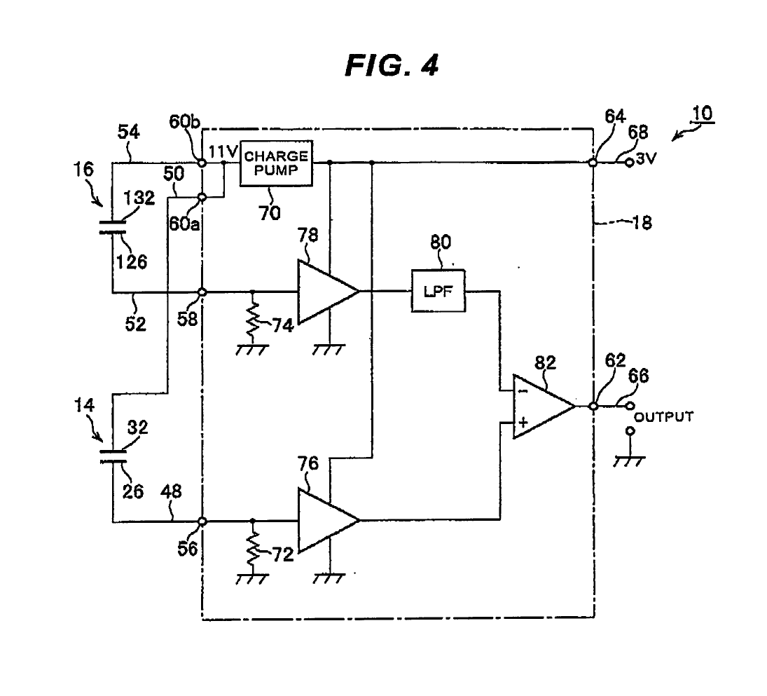

FIG. 4 is a circuit diagram of the condenser microphone 10 with the above-described structure. For example, 3V power supply voltage is supplied to the terminal 64 of the LSI18 for impedance conversion via the lead wire 68. This voltage pressure is raised to, for example, 11V, by a charge pump 70 and is respectively imposed on the back plates 32 and 132 of both of the elements 14 and 16 as bias voltage. The diaphragm 26 of the condenser microphone element 14 is grounded via a high resistance 72 from giga-ohm to tera-ohm orders. Voltage (electric potential of the diaphragm 26) of both ends of the resistance 72 is input to a buffer amplifier 76 composing the impedance converter.

The diaphragm 126 of the acceleration sensor element 16 is grounded via a high resistance 74 from giga-ohm to tera-ohm orders. Voltage (electric potential of the diaphragm 126) of both ends of the resistance 74 is input to a buffer amplifier 78 composing the impedance converter. High-frequency component of output signals of the buffer amplifier 78 is removed with a low-pass filter 80. A subtraction device 82 subtracts the output signals of the low-pass filter 80 at the acceleration sensor element 16 side from the output signals of the buffer amplifier 78 at the condenser microphone element 14 side. Output signals of the subtraction device 82 are output from the terminal 62 as microphone output and are supplied to an amplifier (not shown in the drawings) in a latter step via the lead wire 66.

According to the circuit in FIG. 4, when the diaphragm 26 of the condenser microphone element 14 oscillates, capacity of the condenser microphone element 14 changes by change in distance between the diaphragm 26 and the back plate 32 involved by the oscillation. The capacity change of the condenser microphone element 14 brings change in the electric potential of the diaphragm 26 by the high resistance 72, and this change in the electric potential is input to an input end of the subtraction device 82 via the buffer amplifier 82. Moreover, when the diaphragm 126 of the acceleration sensor element 16 oscillates, capacity of the acceleration sensor element 16 changes by change in distance between the diaphragm 126 and the back plate 132 involved by the oscillation. The capacity change of the acceleration sensor element 16 brings change in the electric potential of the diaphragm 126 by the high resistance 74, and this change in the electric potential is input to another input end of the subtraction device 82 via the buffer amplifier 78 and the low-pass filter 80. Subtraction of both input signals by the subtraction device 82 is performed, and the calculation result is output as a microphone output.

Difference in frequency properties of the output signals corresponding to the sound according to the difference in diameters of the back cavities of the condenser microphone elements (condenser microphone element 14 and the acceleration sensor element 16) will be explained. Measurements a to f of parts of the condenser element shown in FIG. 5 are defined as follows. The reference numbers used for explanation of the condenser microphone element 14 will be used as the reference numbers of the parts in FIG. 5 for convenience.

a . . . Diameter of the opening parts 38 of the insulating layers 24 and 30: 325 μm (fixed).

b . . . Width of the pierced hole 46 for pressure adjustment of the diaphragm 26: 30 μm (fixed).

c . . . . Thickness of a slit 84 between the substrate 22 and the diaphragm 26 (thickness of the insulating layer 24): 2 μm (fixed).

d . . . Width of the slit 84: 50 to 0.5 μm (variable).

e. Diameter of the back cavity 20: 275 to 324.5μ (variable) (however, d+e=325 μm constant).

f . . . Height of the back cavity 20: 512 μm (fixed).

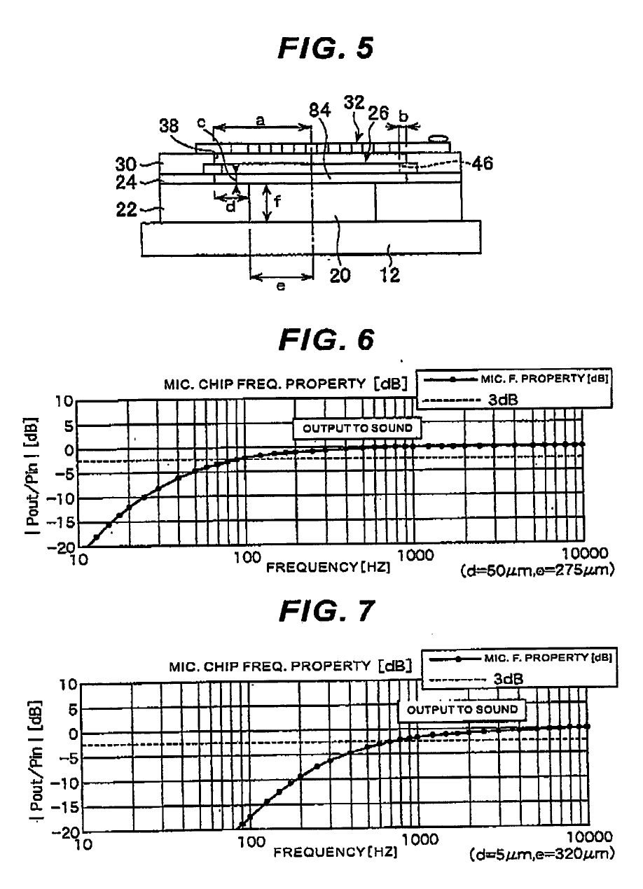

FIG. 6 to FIG. 9 show frequency properties according to simulations of output signals of the condenser elements when the above measurements d and e are set to be variable. FIG. 6 shows the property when the slit width d is set to 50 μm and the diameter of the back cavity e is set to 275 μm. At this time, cut-off frequency is 80 Hz, and sufficient property as a microphone can be obtained.

FIG. 7 shows the property when the slit width d is set to 5 μm and the diameter of the back cavity e is set to 320 μm. At this time, cut-off frequency is 600 Hz, and the property is not fully sufficient for a microphone.

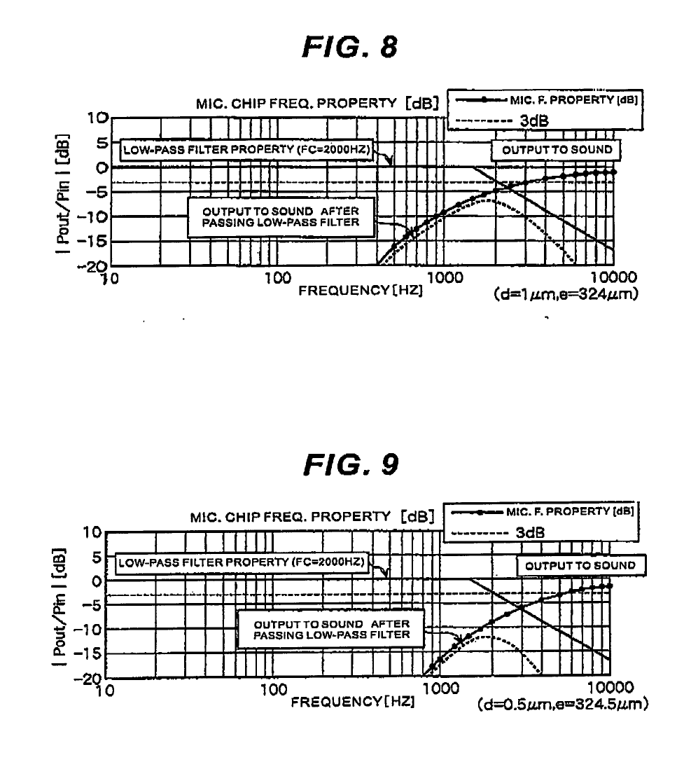

FIG. 8 shows the property when the slit width d is set to 1 μm and the diameter of the back cavity e is set to 324 μm. At this time, cut-off frequency is 3000 Hz, and it cannot be used as a microphone with this property. On the other hand, if it is used as the acceleration sensor, it is necessary to remove the high frequency component with the low-pass filter because sensitivities in the high frequency are high. Property of the low-pass filter wherein the cut-off frequency is set to 2000 Hz and the property at a time of passing the output signals of the condenser element 14 to this low-pass filter are shown in FIG. 8. According to this, as the property at a time of passing the output signals of the condenser element 14, level in midrange is relatively large. Therefore, when it is used as the acceleration sensor, frequency property of subtraction output (final microphone output) is affected (midrange component of the microphone output is relatively attenuated).

FIG. 9 shows the property when the slit width d is set to 0.5 μm and the diameter of the back cavity e is set to 324.5 μm. As same as FIG. 8, the property of the low-pass filter wherein the cut-off frequency is set to 2000 Hz and property at a time of passing the output signals of the condenser element 14 to this low-pass filter are shown. According to this, as the property at a time of passing the output signals of the condenser element 14, the level in midrange becomes sufficiently low. Therefore, when it is used as the acceleration sensor, the final microphone output (subtraction output) is not affected very much. Therefore, it can be used as the acceleration sensor. When the low-pass filter is used after setting slit width d to 0 μm and diameter of the back cavity e to 325 μm (that is, the structure of the acceleration sensor element 16 in FIG. 1), the final microphone output (subtraction output) will be more lightly affected, and it will be more suitable as the acceleration sensor.

According to the above-described simulation, when the slit width d is set to 50 μm or more shown in FIG. 6 as the condenser microphone element 14 and when the slit width d is set to 0.5 μm or less (including 0 μm) in FIG. 9 as the acceleration sensor element 16, it will be suitable for an impact-resistant microphone because sensitivity as a microphone can be high and sensitivity to the impact can be low.

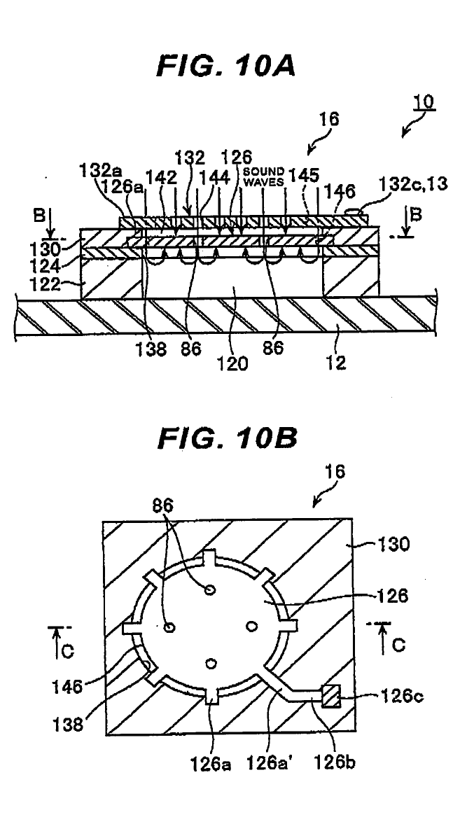

The second embodiment of the present invention will be explained. Pierced holes are formed on an inside surface of the diaphragm 126 of the acceleration sensor element 16 according to the before-described first embodiment. FIG. 10A and FIG. 10B are diagrams showing an example of a structure of an acceleration sensor element 16. FIG. 10A is a cross sectional view as viewed from positions of arrows C-C in FIG. 10B, and FIG. 10B is a cross sectional view as viewed from positions of arrows B-B in FIG. 10A. A few numbers of pierced holes 86 with a diameter of approximately 1 μm are formed on the inside surface of the diaphragm 126 at equal arrangement. Other structure is same as that of the condenser microphone 10 in FIG. 1. The pierced hole is not formed inside surface of the condenser microphone element 14. Since a part of the sound wave irradiated to inside surface of the diaphragm 126 of the acceleration sensor element 16 passes through the pierced holes 86 to the back of the diaphragm 126, an amount of the sound wave passing to the back of the diaphragm 126 increases than that in the first embodiment by coupling with the amount of the sound wave passing through the pierced hole 146 for pressure adjustment to the diaphragm 126, and sensitivities to the sound will be lower. Therefore, sensitivities to the sound as a whole condenser microphone 10 will be high (microphone output after subtracting will be larger).

Although both of the elements 14 and 16 are configured as respectively independent chips in the before-described first and second embodiments, they can be formed on a same chip. Moreover, although the case of using the elements of normal condenser microphone element type as the condenser microphone element 14 and the acceleration sensor element 16 has been explained in the before-described embodiments, elements of electret condenser microphone type can be used for the both elements 14 and 16. Furthermore, although both elements 14 and 16 has same measurement other than having different diameter of the back cavities 20 and 120, it is not necessary to have same measurement, for example, both elements 14 and 16 can be composed with plus/minus 10 percent measurement difference.

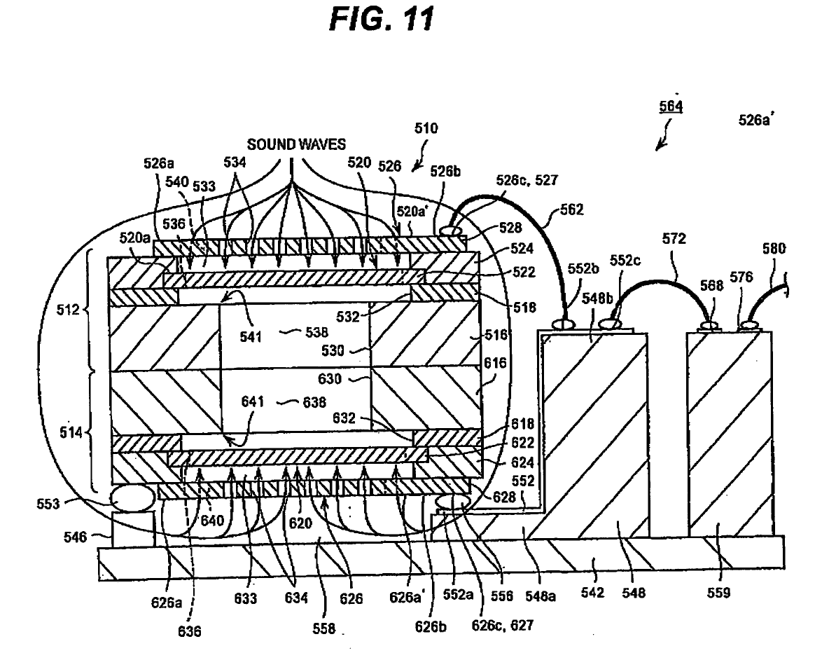

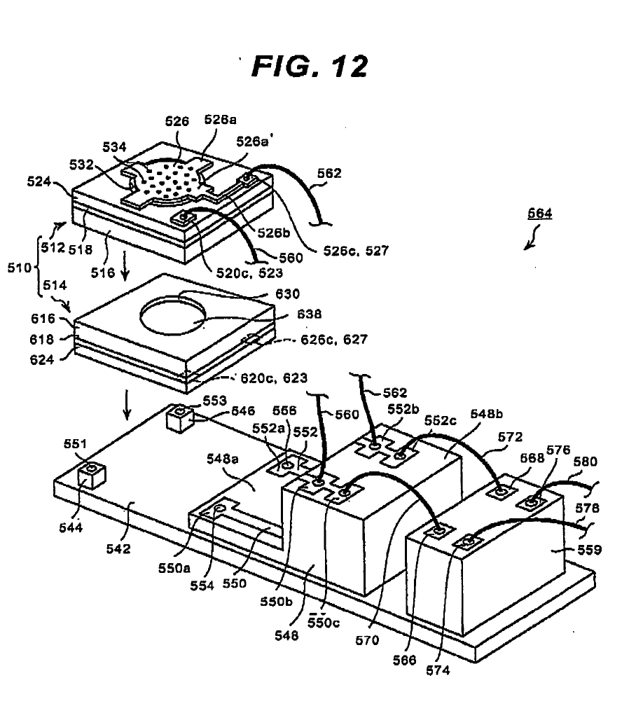

FIG. 11 is a cross sectional view cut the whole microphone assembly in a half in a longitudinal direction. FIG. 12 is a decomposition perspective view of the condenser microphone 510.

As shown in FIG. 11, the condenser microphone 510 consists of two units of condenser microphone elements 512 and 514. Both condenser microphone elements 512 and 514 connect with each other on their back surfaces in airtight to be integrated and form the condenser microphone 510. These condenser microphone elements 514 and 516 are configured as a silicon microphone by using the MEMS process. Moreover, the both elements 14 and 16 may be composed by assembling individual parts in a case of a relatively large condenser microphone.

First, the condenser microphone element 512 will be explained. The condenser microphone element 512 is formed by forming an insulating layer 518 by silica film on a surface of a substrate 516 composed of silicon and the like and thereon forming a conductive film 522 composing a diaphragm (oscillating plate) 520, an insulating layer 524 made of silica film and the like and a conductive film 528 composing a back plates (back electrode plate, fixing electrode) 526 in sequence with the semiconductor manufacturing process. An opening part (pierced hole) 530 having a circular cross section is formed in the center of the substrate 516. An opening part (pierced hole) 532 having circular cross section is formed in communication with the opening part 530 in the center parts of the insulating layers 518 and 524 in a same axis as the opening part 530 of the substrate 516. A diameter of the opening part 530 of the substrate 516 is smaller than that of the opening parts 532 of the insulating layer 518, and a step 541 is formed at a border part. The opening part 530 of the substrate 516 forms a back cavity (back air chamber) 538. A space 533 with a fixed length is formed between the back plate 526 and the diaphragm 520. Plurality of pierced holes 534 are formed on the back plate 52e. Sound waves by a sound generated outside enter to the space 533 from those pierced holes 534 and hit on the surface of the diaphragm 520 to drive the diaphragm 520.

A pierced hole (a slit) 536 with narrow width for pressure adjustment is formed on a peripheral rim of the diaphragm 520 to pass the sound waves to the back cavity 538 via the pierced holes 534 and 540 (later described) of the back plate 526. A width (slit width) of the pierced hole 536 for pressure adjustment may be relatively narrow which is sufficient for keeping the pressure in the back cavity 538 as same as pressure in the upper space of the diaphragm 520 regardless of change in temperature. Sound waves entered from outside to the surface of the diaphragm 520 via the pierced holes 534 and 540 of the back plate 526 attempt to pass through the pierced hole 536 for pressure adjustment to the back cavity 538; however, the sound waves hardly pass through the pierced hole 536 for pressure adjustment to the back cavity 538 because the opening part 530 of the substrate 516 is formed smaller than the opening part 532 of the insulating layer 518 and sound resistance of the back cavity 538 is large at a step 541 (border part of the opening part 530 and 532) positioned at a mid-position in the axis direction. When the sound waves reach to the diaphragm 538, the sound waves cancelled each other on the front and back surfaces of the diaphragm 520, oscillation of the diaphragm 520 will decrease, and sensitivity to the sound becomes low. However, diaphragm 520 sufficiently oscillates to the sound because the sound waves hardly pass through the pierced hole 536 for pressure adjustment to the back cavity 538, and sufficient sensitivity can be obtained.

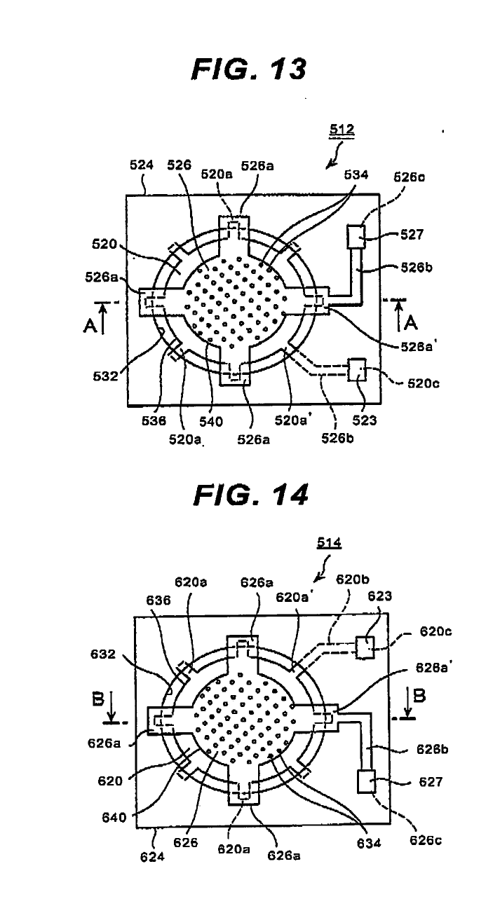

FIG. 13 is a plan view of the condenser microphone element 512 in FIG. 11 from the back plate 526. A structure of the cross section of the condenser microphone element 512 shown in FIG. 11 is equivalent to the cross section as viewed at positions of arrows A-A in FIG. 13. As shown in FIG. 13, a plan shape of the diaphragm 520 is formed in a circular shape with slightly smaller diameter than the opening parts 532, and a supporting part 520a projecting to outside is formed and arranged at the peripheral rim at equiangular intervals. The diaphragm 520 is positioned in concentric to the opening parts 532 and fixed and supported on the insulating layer 518 by the supporting parts 520a. By that, the pierced hole 536 with narrow width for pressure adjustment is formed between the opening parts 532 and the peripheral rim of the diaphragm 520. One (520a′) of the supporting parts 520a is extended to compose a lead wire 520b. An end of the lead wire 520b pierces through the insulating layer 524 and reaches to the surface of the insulating layer 524 to compose a terminal base 520c. A terminal 523 made of an aluminum film is covered and formed on a surface of the terminal base 120c.

As shown in FIG. 13, the back plate 526 is formed in a smaller circular shape than that of the diaphragm 520, and supporting parts 526a projecting outside are formed and arranged at the peripheral rim. The back plate 526 is positioned and fixed in concentric to the opening parts 532 and supported on the insulating layer 524 by the supporting parts 526a. By that, a pierced hole (slit) 540 having wider width than the pierced hole (slit) 536 is formed between the opening parts 532 and the peripheral rim of the back plate 526. Sound waves enter to the space 533 via the pierced hole 540 and the pierced hole 536 formed inside the back plate 526 to drive the diaphragm 520. One (526a′) of the supporting parts 526a is extended to compose a lead wire 526b. An end of the lead wire 526b composes a terminal base 526c on the insulating layer 524. A terminal 527 made of an aluminum film is covered and formed on a surface of the terminal base 126c.

An example of manufacturing process of the condenser microphone 512 by the micro electro mechanical systems (MEMS; a semiconductor manufacturing) process will be explained.

(1) The insulating layer 518 and the conductive film 522 are formed in sequence on the substrate 516 in which the opening 530 has not been formed yet.

(2) The conductive film 522 is patterned by a photolithography technique, and the supporting parts 520a, 520a′, and the lead wire 520b (FIG. 13) which are connecting to the diaphragm 520 and the conductive film 522 are formed,

(3) An insulating layer 524 is formed.

(4) The pierced hole through the lead wire 520b is formed at a part of the insulating layer 524 by etching.

(5) The conductive film 528 is formed on the insulating layer 524. At this time, the conductive films are deposited also in the above-described pierced hole of the insulating layer 524 and are connected with the lead wire 520b to be conductive.

(6) The conductive film 528 is patterned by photolithography, and the supporting parts 526a, 526a′, the lead wire 526b and the terminal base 526c which are connecting with the back plate 626 and the conductive film 528 are formed. At this time, the pierced hole 534 is formed on the back plate 526 simultaneously. Moreover, the terminal base 520c connecting with the lead wire 520b of the diaphragm 520 is also formed.

(7) Aluminum film and the like are formed by sputtering as covering at least a region where terminals 523 and 527 will be formed, and the terminal 523 that is conductive to the terminal base 520c and the terminal 527 that is conductive to the terminal base 526c are respectively formed.

(8) The back surface of the substrate 516 is etched until the insulating layer 518 is exposed, and thereafter the opening part 530 is formed.

(9) The center parts of the insulating layer 518 and 624 are selectively etched and removed from both of the front and back surfaces of the substrate 516 by using etching liquid such as fluorinated acid and the like. That is, the etching liquid enters from the opening part 530 to the back side, and the center part of the insulating layer 518 is etched and removed to form opening parts 532. Moreover, the etching liquid enters from the pierced holes 534 and 540 to the front side, and the center part of the insulating layer 524 is etched and removed to form a space 533. The pierced holes are formed by etching, and the opening parts 630 and 532 are connected to each other.

As described in the above, the condenser microphone 512 is formed.

Another condenser microphone element 514 has a same structure as the condenser microphone element 512 (even though the terminals are opposing to each other as shown in FIG. 13 and FIG. 14). By that, both condenser microphone elements 512 and 514 have same properties such as that the inertia moments are same. The condenser microphone element 514 can be manufactured by the same method as the condenser microphone element 512. In the condenser microphone 514, the same components as in the condenser microphone 512 are represented by the reference numbers added with 100 to those representing the components of the condenser microphone 512, and explanations for those same components will be omitted. The cross sectional structure of the condenser microphone element 514 in FIG. 11 is equivalent to the cross section as viewed from positions of arrows B-B in FIG. 14.

The above-described condenser microphone elements 512 and 514 are connected with each other on the back surfaces in airtight by adhesive to be integrated and form a condenser microphone 510 in FIG. 11. The back cavities 538 and 638 of the both condenser microphone elements 512 and 514 are connected with each other. This condenser microphone 510 is used by mounting on the substrate 542. That is, as shown in FIG. 12, bases 544, 546 and 548 made of insulating material such as plastic, glass epoxy and the like are fixed on the substrate 542 by adhesive. The base 548 has two steps, and height of a lower base part 548a is about the same as the bases 544 and 546. Two lead wires 550 and 552 by printing wire are formed in parallel from the lower base part 548a to a higher base part 548b, and two terminals 150b and 150c are formed at the higher base part 548b. A terminal 552a is formed on the lead wire 552 at the lower base part 548a, and terminals 552b and 552c are formed on the lead wire 552 at the higher base part 548b.

The condenser microphone 510 is supported at four back corners by the bases 544 and 546 and the lower base part 148a to be connected and fixed in parallel to the substrate 542. That is, the condenser microphone 510 is connected to the base 544 and 546 by adhesive 551 and 553 and fixed on the terminals 550a and 552a of the base part 548a. At this time, a terminal 623 of the diaphragm 620 of the condenser microphone element 514 is electrically connected with the terminal 550a of the base part 548a via a conductive adhesive 554. Moreover, terminal 627 of the diaphragm 626 of the condenser microphone element 514 is electrically connected with the terminal 552a of the base part 548a via a conductive adhesive 556. By doing this, when the condenser microphone 510 is supported, adhered and fixed to the bases 544 and 546 and the lower base part 548a, a space 558 to enter the sound waves between the condenser microphone 510 and the substrate 542 is formed as shown in FIG. 11. Therefore, height of the bases 544 and 546 and base part 148a are formed so that the space 558 is formed sufficiently high for entering the sound waves. Moreover, an LSI 559 for impedance conversion is fixed on the substrate 542 by adhesive.

Wirings on the above-described microphone assembly 564 having the condenser microphone 510 and the LSI 559 for impedance conversion mounted on the substrate 542 will be explained. One end of a lead wire 560 is connected to the terminal 523 of the diaphragms 520 of the condenser microphone element 512 by soldering in FIG. 12. Another end of the lead wire 560 is connected to the terminal 550b on the base 548 by soldering. By this, the diaphragms 520 and 620 of the both condenser microphone elements 512 and 514 are electrically (in same potential) connected each other via the lead wires 550 and 560. One end of a lead wire 562 is connected to a terminal 627 of the back plate 526 of the condenser microphone element 512 by soldering. Another end of the lead wire 562 is connected to a terminal 552b on the base 548 by soldering. By this, the back plates 526 and 626 of the both condenser microphone elements 512 and 514 are electrically (in same potential) connected to each other via the lead wires 552 and 562.

The terminal 550c for the diaphragm on the base 548 and a terminal 566 of the LSI 559 for impedance conversion are connected to each other by soldering the lead wire 570. The terminal 552c for the back plate and a terminal 568 of the LSI 559 for impedance conversion are connected to each other by soldering a lead wire 572. Lead wires 578 and 580 are respectively connected to terminals 574 and 576 of the LSI 559 for impedance conversion. The microphone assembly 564 with the above-described structure is used in various microphone devices (microphone for stages, microphone for studios and the like) and various devices such as a receiver/transmitter of a telephone or a radio device, cellular phone, sound recorder and the like.

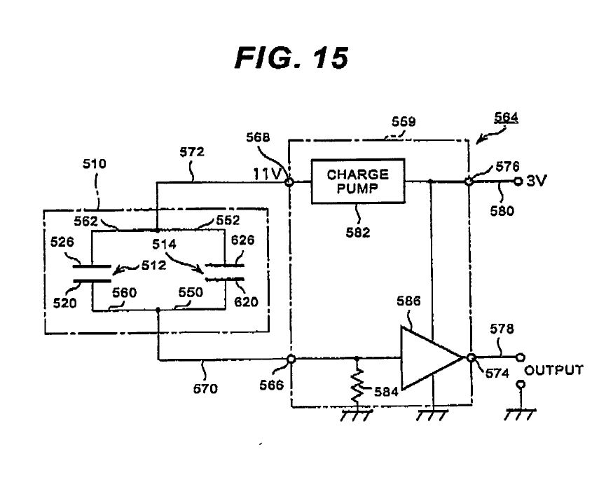

FIG. 15 is a circuit diagram of the microphone assembly 564 in FIG. 11. The diaphragms 520 and 620 are electrically connected to each other via the lead wire 550 and 560. Moreover, the back plates 526 and 626 of the both condenser microphone elements 512 and 514 are electrically connected to each other via the lead wires 552 and 562. For example, 3V power supply voltage is supplied to the terminal 576 of the LSI 559 for impedance conversion via the lead wire 580. This voltage pressure is raised to, for example, 11V, by a charge pump 582 and is respectively imposed on the back plates 526 and 626 of both of the elements 514 and 516 as bias voltage. The diaphragms 520 and 620 of the condenser microphone element condenser microphone 510 are grounded via a high resistance 584 from giga-ohm to tera-ohm orders. Voltage (electric potential of the diaphragms 520 and 620) of both ends of the resistance 584 is input to a buffer amplifier 586 composing the impedance converter. Output signals of the buffer amplifier 586 are output from the terminal 574 via the lead wire 578 to supply to an amplifier (not shown in the drawings) in a latter step.

According to the circuit shown in FIG. 15, when the diaphragms 520 and 620 oscillate, capacity of the condenser microphone elements 512 and 514 changes by change in distance between the diaphragms 520 and 620 and the back plates 526 and 626 involved by the oscillation. That is, capacity of the condenser microphone elements 512 and 614 will be large at a timing that the distance becomes narrow, and the capacity will be small at timing that the distance becomes wide. Since the diaphragms 520 and 620, and the back plates 526 and 626 are electrically connected to each other, the condenser microphone elements 512 and 514 compose one condenser, and capacity change as a whole will be sum of the capacity change of the condenser microphone elements 512 and 514. The sum of the capacity change of the condenser microphone elements 512 and 514 brings change in the electric potentials of the diaphragms 520 and 620 by the high resistance 574, and this change in the electric potential is output via the buffer amplifier 586.

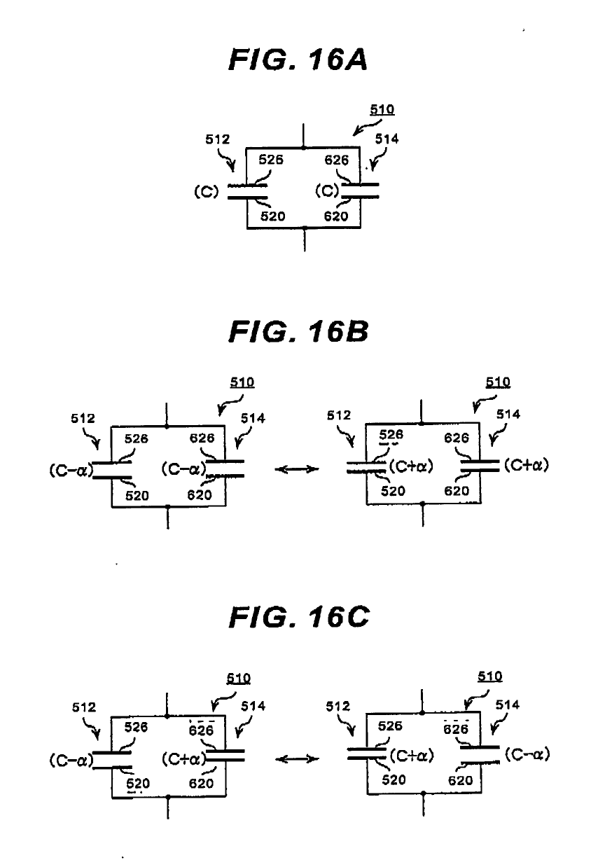

FIG. 16A to FIG. 16C are pattern diagrams showing relationships between capacities of the condenser microphone elements 512 and 514 and differences between movements of the diaphragms 520 and 620 of the condenser microphone 610 when sound waves by a sound from outside are transmitted to the apparatus mounting the microphone assembly 564 and when an impact is given from outside such as hitting the apparatus to something. FIG. 16A shows a neutral state without sound waves and the impact. At this time, the capacities of both condenser microphone elements 512 and 514 are same. Therefore, when defining each of capacities of the condenser microphones 512 and 514 as C, the whole capacity of the condenser microphone 510 will be 2C.

FIG. 16B shows movements when sound waves by a sound from outside are input. At this time, equal sound waves are transmitted to the diaphragms 520 and 620 of the condenser microphone 510. That is, as shown in FIG. 11, the sound waves enter from the pierced hole 534 on the back plate 526 and oscillate the diaphragm 520 at the condenser microphone element 512. Moreover, the sound waves enter from the pierced hole 634 of the back plate 626 via the space 558 between the substrate 542 and the condenser microphone 510 and oscillate the diaphragm 620 at the condenser microphone element 514. At this time, as shown in FIG. 16B, diaphragms 520 and 620 elongate to the back plates 526 and 626 simultaneously (left in the drawing) and approach to the back plates 526 and 626 to oscillate. That is, in the neutral state, diaphragms 520 and 620 displace in the same phase to the back plates 526 and 626. An amount of the capacity change when the diaphragms 520 and 620 elongate to the back plate 526 and 626 is defined to respectively −α, and the amount of the capacity change when the diaphragms 520 and 620 approach to the back plates 526 and 626 is defined to respectively +α. The whole capacity of the condenser microphone 510 will be 2(C−α) when the diaphragms 520 and 620 elongate to the back plates 526 and 626, and it will be 2(C+α) when the diaphragms 520 and 620 approach to the back plates 526 and 626. Therefore, ideal state of the capacity change of the whole condenser microphone 510 will be ±2a, and it will be twice of the amount of the capacity change a of single change of each of the condenser microphone elements 512 and 514. By that, the same sensitivity as the case independently using each of the condenser microphone elements 512 and 514 can be obtained to the sound, and S/N ratio will be improved.

FIG. 16C shows movements when the impact from outside is input. At this time, since the same impact is brought to the diaphragms 520 and 620 of the condenser microphone 510 in the same direction, the diaphragms 520 and 620 displace for the same amount in the same direction and in inertia by the impact. At this time, since the condenser microphone elements 512 and 514 are connected with each other on their back surfaces, the diaphragms 520 and 620 displace so that relationship of elongation and approach to the back plates 526 and 626 opposes to each other. That is, as shown in the left diagram in FIG. 16C, when the diaphragm 520 elongates to the back plate 526, the diaphragm 620 approaches to the back plate 526. Moreover, as shown in the right diagram in FIG. 16C, when the diaphragm 520 approaches to the back plate 526, the diaphragm 620 elongates to the back plate 526. That is, the capacity of the whole condenser microphone 510 will be (C−α)+(C+α)=2C in the case of the left diagram in FIG. 16C, and it will be an ideal state. Moreover, the capacity of the whole condenser microphone 510 will be (C+α)+(C−α)=2C in the case of the right diagram in FIG. 16C, the capacity will not change from the neutral state in FIG. 16A. By that, as compared to the case using each of the condenser microphone elements 512 and 514 independently, sensitivity to the sound from outside becomes low, and generation of the impact sound can be restrained.

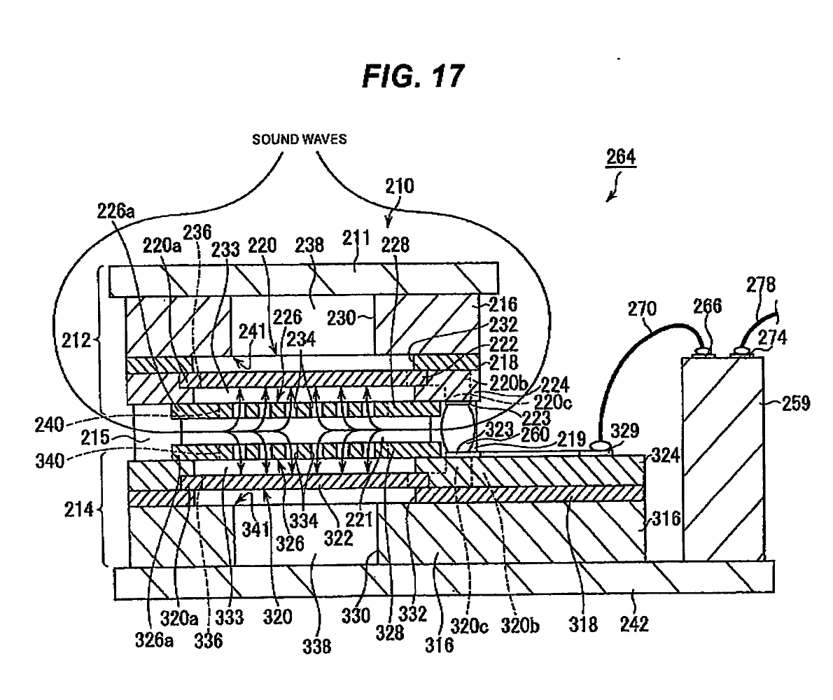

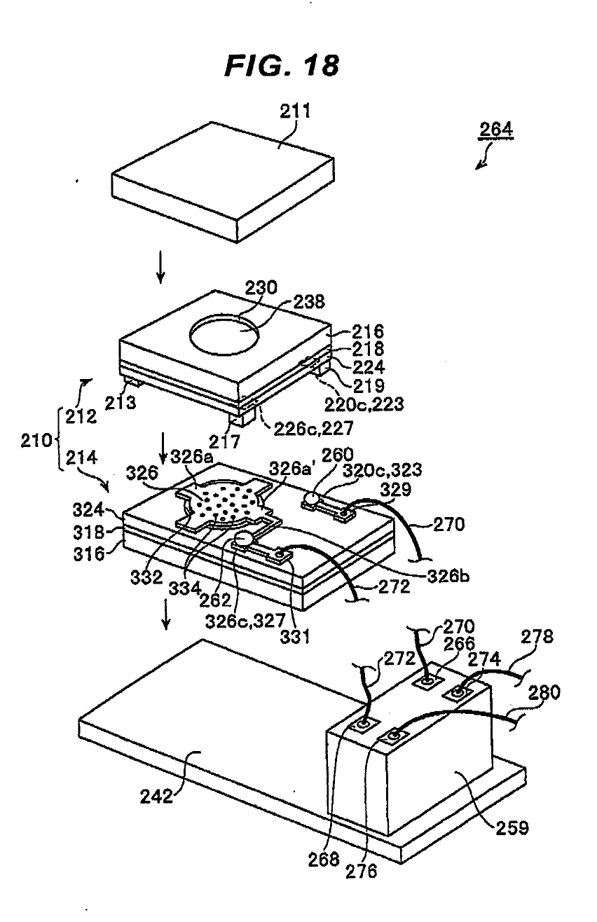

FIG. 17 is a cross sectional view of a condenser microphone cut in a longitudinal direction according to a fourth embodiment of the present invention. FIG. 18 is a decomposition perspective view of the microphone assembly in FIG. 17. The similar components as the third embodiments are represented by the reference numbers subtracted by 300. That is, the same components are represented by the same lower two-digit numbers.

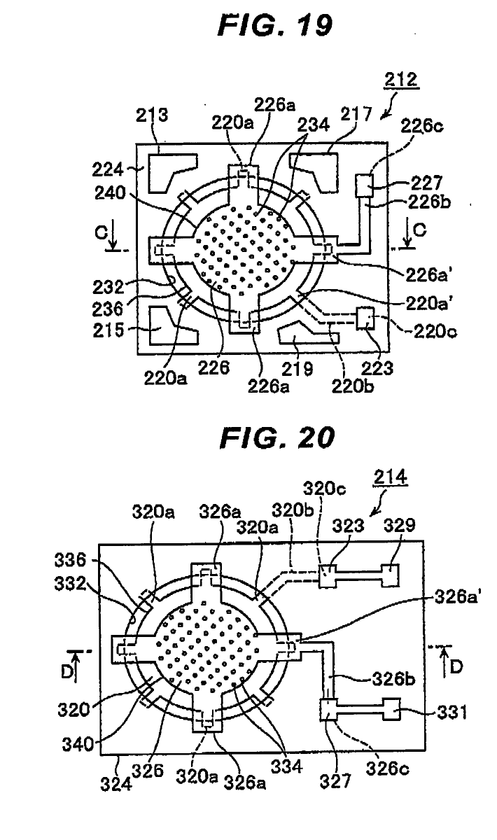

As shown in FIG. 17, a condenser microphone 210 is composed of two units of condenser microphone elements 212 and 214. Both condenser microphone elements 212 and 214 are faced to each other, and they are connected across spacers 213, 215, 217 and 219 to be integrated to compose the condenser microphone 210. These condenser microphone elements 212 and 214 are configured as a so-called silicon microphone by using a MEMS process. When the condenser microphone 210 is relatively large, both of the condenser microphone elements 212 and 214 can be composed by assembling individual parts. FIG. 19 is a plan view of the condenser microphone element 212 in FIG. 17 from a back plate 226. The cross sectional structure of the condenser microphone element 212 in FIG. 17 is equivalent to the cross section as viewed from positions of arrows C-C in FIG. 19. Moreover, FIG. 20 is a plan view of the condenser microphone element 214 in FIG. 17 from a back plate 326. The cross sectional structure of the condenser microphone element 214 in FIG. 17 is equivalent to the cross section as viewed from positions of arrows D-D in FIG. 20.

Only different parts of the fourth embodiment from the third embodiment will be explained, and the explanations for the similar parts will be omitted. A back cavity 238 of the condenser microphone element 212 is sealed at an opening end part of a substrate 216 by adhering a plate material 211. Spacers 213, 215, 217 and 219 with same height, made of insulating material such as silica film and the like are formed around four corners of the surface of the condenser microphone element 212 not to overlap with other pattern such as the back plate 226. A substrate 316 of the condenser microphone element 214 is formed extending its width comparing to the substrate 216 of the condenser microphone element 212. Terminals 323 and 329 of a diaphragm 320 and terminals 327 and 331 of a back plate 326 are formed on the extended region. The terminals 323 and 329 are connected with each other. The terminals 327 and 331 are connected with each other. The condenser microphone elements 212 and 214 can be manufactured by the same method by the MEMS process as manufacturing the condenser microphone elements 512 and 514 in the third embodiment.

Both condenser microphone elements 212 and 214 are faced to each other, and tips of the spacers 213, 215, 217 and 219 are adhered on the surface of the condenser microphone element 214 by adhesive to integrate, and the condenser microphone 210 in FIG. 17 is formed. By that, a space 221 to which the sound waves enter is formed between the condenser microphone elements 212 and 214, and the sound waves from outside pass through this space 221 to the condenser microphone element 521 and 214. Therefore, height of the spacers 213, 215, 217 and 219 are set in order to take-in sufficient sound waves.

Wirings on the microphone assembly 264 will be explained. As shown in FIG. 18, a terminal 223 of the condenser microphone element 212 and a terminal 323 of the condenser microphone element 214 are faced to each other, and a solder ball 260 is put between both of the terminals 223 and 323. Then, both terminals 223 and 323 are connected by melting the solder ball 260 by heating. By that, the diaphragms 220 and 320 of the condenser microphone elements 212 and 214 are electrically (in the same electric potential) connected via the solder ball 260. Moreover, a terminal 227 of the condenser microphone element 212 and a terminal 327 of the condenser microphone element 214 are faced to each other, and a solder ball 262 is put between both of the terminals 227 and 327. Then, both terminals 227 and 327 are connected by melting the solder ball 262 by heat. By that, the back plates 226 and 326 of the condenser microphone elements 212 and 214 are electrically (in the same electric potential) connected via the solder ball 262.

A terminal 329 for the diaphragm and a terminal 266 of a LSI 259 for impedance conversion on the condenser microphone element 214 are connected to each other by soldering a lead wire 270. A terminal 331 for the back plate and a terminal 268 of the LSI 259 for impedance conversion on the condenser microphone element 214 are connected to each other by soldering a lead wire 272. Lead wires 278 and 280 are respectively connected to terminals 274 and 276 of the LSI259 for impedance conversion. As described in the above, the circuit structure will be same as that in FIG. 15 showing the third embodiment.

Operations when sound waves by a sound from outside is input to the apparatus mounting the microphone assembly 264 and when an impact is given from outside such as hitting the apparatus to something will be explained. As shown in FIG. 17, when the sound waves are input from outside, the sound waves pass through the space 221 formed by the spacers 213, 215, 217 and 219 through the pierced hole 234 of the back plate 226 of the condenser microphone element 212 and oscillate the diaphragm 220. Moreover, the sound waves pass through the pierced hole 334 of the back plate 326 of the condenser microphone element 214 and oscillate the diaphragm 320. At this time, the diaphragms 220 and 320 oscillate by simultaneously elongating and approaching to the back plates 226 and 326. That is, the diaphragms 220 and 320 displace in the same phase to the back plates 226 and 326. Therefore, as same as the third embodiment, an amount of capacity change of whole of the condenser microphone 210 will be twice of that using the condenser microphone elements independently and it is an ideal state. By that, the same sensitivity as the case independently using each of the condenser microphone elements 212 and 214 can be obtained to the sound, and S/N ratio will be improved.

On the other hand, when an impact is given from outside such as the apparatus is hit to something, the same impact is given to the diaphragms 220 and 320 of the condenser microphone 210 in the same direction. At this time, because the condenser microphone elements 212 and 214 are connected with each back surface, the diaphragms 220 and 320 oscillate so that relationships of elongation and approach to the back plates 226 and 326 become opposite to each other. Therefore, as same as the third embodiment, the capacity of the whole condenser microphone 210 is ideal state and does not change. By that, sensitivity to the impact from outside will be lower than the case using each of the condenser microphone elements 212 and 214 independently, and generation of the impact sound will be restrained.

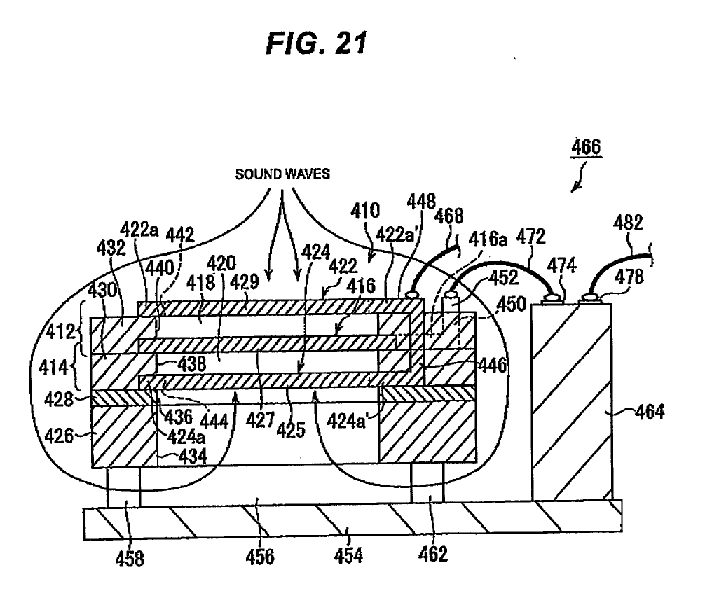

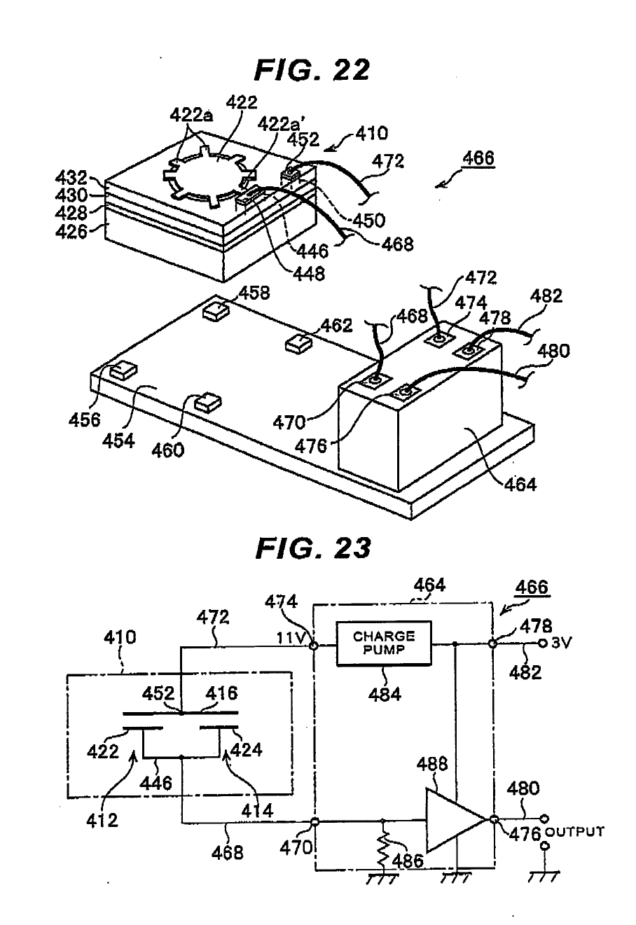

FIG. 21 is a cross sectional view of a condenser microphone cut in a longitudinal direction according to a fifth embodiment of the present invention. FIG. 22 is a decomposition perspective view of the microphone assembly in FIG. 21. As shown in FIG. 21, the condenser microphone 410 is configured of two pairs of condenser microphone elements 412 and 414. The condenser microphone elements 412 and 414 have a common back plate 416 and have diaphragms 422 and 424 respectively above and below the back plate 416 via spaces 418 and 420 with same height. The condenser microphone 410 is formed as a so-called silicon microphone by using the MEMS process. When the condenser microphone 410 is relatively large, individual parts can be configured by assembling.

Detailed configuration of the condenser microphone 410 will be explained. The condenser microphone 410 is formed by sequentially forming an insulating layer 428 made of a silica-film, etc., the diaphragm 424, an insulating layer 430, the back plate 416, an insulating layer 432 and the diaphragm 422 on a surface of a substrate 426 such as silicon and the like. An opening part (pierced hole) 434 with a circular cross section is formed in the center of the substrate 426. In the central parts of the insulating layers 428, 430 and 432, opening parts (pierced holes) 436, 438 and 440 are formed respectively. The back plate 416 has no pierced hole, and a space between the spaces 418 and 420 is shut by the back plate 416. Each of the diaphragms 422 and 424 has a narrow pierced hole 442 or 444 for adjusting air pressure, and the pierced holes 442 and 444 connects the spaces 418 and 420 to an open air. The diaphragms 422 and 424 are electrically connected to each other via a lead wire 446 piercing through the insulating layers 430 and 432 and form a terminal 448 on a surface of the condenser microphone 410. A lead wire of the back plate 416 pierces through the insulating layer 432 and forms a terminal 452 on the surface of the condenser microphone 410.

An example of manufacturing process of the condenser microphone 410 by the micro electro mechanical systems (MEMS: a semiconductor manufacturing) process will be explained.

(1) The insulating layer 428 and the conductive film 425 are formed in sequence on the substrate 426 in which the opening 434 has not been formed yet.

(2) The conductive film 425 is patterned by a photolithography technique, and the diaphragm 424 and a supporting part 424a which are connecting to the diaphragm 424 are formed. One (424a′) of the supporting parts 424a is extended for connecting to the lead wire 446.

(3) The insulating layer 430 is formed.

(4) The conductive film 427 is formed on the insulating layer 430.

(5) The conductive film 427 is patterned by photolithography to form the back plate 416. A part of the outer peripheral rim of the back plate 416 is extended to form the lead wire 416a.

(6) The insulating layer 432 is formed.

(7) Pierced holes reaching to the lead wire 424a′ of the diaphragm 424 are formed at a part of the insulating layers 430 and 432 by etching. Moreover, a pierced hole reaching to the lead wire 416a of the back plate 416 is formed at other part of the insulating layer 432 by etching.

(8) The conductive films 429 are formed on the insulating layer 432. At this time, the conductive films 429 are deposited inside the formed pierced holes connecting to the insulating layers 430 and 432 to form the lead wire 446. This lead wire 446 is connected and conducted to the lead wire 424a′ of the diaphragm 424. Moreover, the conductive films 429 are deposited in the formed pierced hole at other part of the insulating layer 432 to form the lead wire 450. This lead wire 450 is connected and conducted to the lead wire 416a of the back plate 416.

(9) The conductive film 429 is patterned by a photolithography technique, and the diaphragm 422 and the supporting parts 422a connected to the diaphragm 422 are formed. One (422a′) of the supporting parts 422a is extended to form the terminal 448. The terminal 448 is connected to the lead wire 446. Moreover, the terminal 452 to be connected to the lead wires 416a and 450 of the back plate 416 is formed at this patterning.

(10) A reverse (back) surface of the substrate 426 is etched until the insulating layer 428 is exposed to form an opening part 434.

(11) Center parts of the insulating layers 428, 430 and 432 are selectively etched and removed by using etching liquid such as fluorinated acid from both of the front and the reverse surfaces of the substrate 426. The etching liquid enters from the opening part 434 to the reverse side, and the center part of the insulating layer 428 is etched and removed to form an opening part 436. Moreover, the etching liquid enters from a transparent hole 444, and the center part of the insulating layer 432 is etched and removed to form a space 420 between the diaphragm 424 and the back plate 416. The etching liquid enters from the transparent hole 442 to the front side of the substrate 426, and the center part of the insulating layer 432 is etched and removed to form a space 418 between the diaphragm 422 and the back plate 416.

As described in the above, the condenser microphone 410 is formed.

Bases 456, 458, 460 and 462 made of insulating material such as plastic, glass epoxy and the like are fixed on a substrate 454 by adhesive. Four corners of the back of the condenser microphone 410 are fixed on the bases 456, 458, 460 and 462 by adhesive and the condenser microphone 410 is supported horizontally to the substrate 454. By that, a space 456 through which sound waves pass is formed between the condenser microphone 410 and the substrate 454. Therefore, the bases 456, 458, 460 and 462 are set to the height to sufficiently form the space 456 to get through the sound waves. A LSI 464 for impedance conversion is fixed on the substrate 454 by adhesive.

Wiring on the above-described microphone assembly 466 mounting the condenser microphone 410 and the LSI464 for impedance conversion on the substrate 454 will be explained. One end of the lead wire 468 is connected to the terminal 448 of the diaphragms 422 and 424 by soldering as shown in FIG. 22. Another end of the lead wire 468 is connected to a terminal 470 of the LSI 464 for impedance conversion by soldering. Moreover, one end of a lead wire 472 is connected to the terminal 452 of the back plate 416 by soldering. Another end of the lead wire 472 is connected to the terminal 474 of the LSI 464 for impedance conversion by soldering. Lead wires 480 and 482 are connected to the terminals 476 and 478 of the LSI 464 for impedance conversion. The microphone assembly 466 with the above-described structure is used by assembling in various devices such as various kinds of the microphone device (a microphone for stage and a microphone for studio), a handset of telephone and a wireless application, a cellular phone, a sound recorder and the like.

FIG. 23 is a circuit diagram of the microphone assembly 464 in FIG. 21. The back plate 416 is commonly used by both of the condenser microphone elements 412 and 414. The diaphragms 422 and 424 are electrically connected (in same electrical potential) via the lead wire 446 in the condenser microphone 410. For example, power supply voltage of 3V is supplied to the LSI 464 for impedance conversion via the lead wire 482. This power supply voltage is raised to, for example, 11V by a charge pump 484, and is imposed to the back plate 416 of the condenser microphone 410 as bias voltage. The diaphragms 422 and 424 of the condenser microphone 410 are grounded via high resistance 486 from giga-ohm to tera-ohm orders. The voltage (electrical potential of the diaphragms 422 and 424) at both sides of the resistance 486 is input to a buffer amplifier 488 configuring the impedance converter. The output signal of the buffer amplifier 488 is output via the lead wire 480 to be supplied to a following amplifier (not shown in the diagram).

The diaphragms 422 and 424 displace in the same phase by a sound from outside. Therefore, as same as the third and the fourth embodiments, a changing amount in the whole capacity of the condenser microphone 410 is ideal at this time, and it will be twice of the changing amount in a single capacity of each condenser microphone elements 412 and 414. By that, sensitivity as same as the case of using each of the condenser microphone elements 412 and 414 independently can be obtained for the sound, and the S/N ratio will be improved than the case using each of the condenser microphone elements 412 and 414 independently.

On the other hand, the diaphragms 422 and 424 displace in the opposite phase by an impact from outside. Therefore, as same as the third and the fourth embodiments, changing amount in the whole capacity of the condenser microphone 410 is ideal at this time, and the whole capacity of the condenser microphone 410 will not change. By that, sensitivity to the impact from outside will decline than the case of using each of the condenser microphone elements 412 and 414 independently, and generation of impact sound can be restrained.

Moreover, in the before-described third to fourth embodiments, two units of the condenser microphone elements are positioned on the same axis; however, they may be positioned mutually displacing the axes (positioning in parallel). Moreover, he before-described third to fourth embodiments may be applicable in an electret condenser microphone.

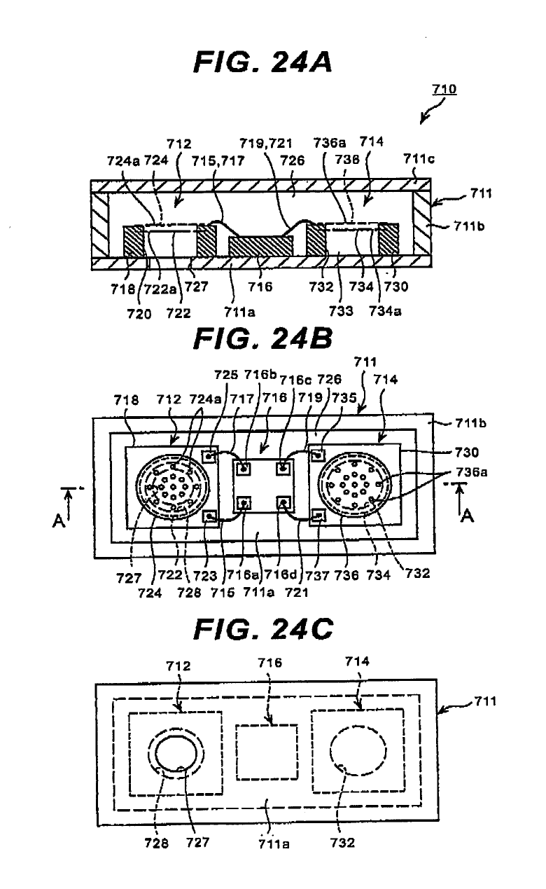

FIG. 24A is a cross sectional view (a cross sectional view as viewed from positions of arrows A-A in FIG. 24B) of a microphone assembly cut in a half in a longitudinal direction. FIG. 24B is a plan view showing a condition when removing a lid plate of the package (casing). FIG. 24C is a plan view as viewed from a bottom. The condenser microphone 710 is formed by configuring condenser elements 712 and 714 and a LSI 716 for impedance conversion and calculation in a package 711 made of metal and the like. The package 711 is formed by assembling a bottom plate 711a, side plates 711b and a lid plate 711c. A sound hole 727 that is an only opening part connecting an internal space of the package 711 to an outer space is formed on the bottom plate 711a. When the condenser microphone 710 is mounted to a device such as a cellular phone, the sound hole is mounted not to be blocked off. The condenser elements 712 and 714 and the LSI 716 for impedance conversion and calculation are fixed on the bottom plate 711a in the package 711.

Structures and properties of the condenser microphone elements 712 and 714 are same, and these are formed as a silicon microphone by using the MEMS process. In FIG. 24, a case the condenser microphone elements 712 and 714 are formed with the silicon microphone is shown. That is, the condenser microphone element 712 is formed by arranging a diaphragm 722 and a back plate 724 opposing to each other with an arbitral space between them inside the opening part 720 of a substrate 718 made of silicon and the like. Plurality of piercing holes 724a are formed on the back plate 724, and sound waves generated by oscillation of the diaphragm 722 pierces through these piercing holes 724a and transmitted to an internal space 726. The opening part 720 is arranged on a same axis as the sound hole 727 of the package 711, and an irradiating surface (a surface where sound waves irradiate, a back of the diaphragm 722 is the irradiating surface in this embodiment) of the sound waves of the condenser microphone element 712 approaches to the sound hole 727. A sound from outside is irradiated from the sound hole 727, passes through the opening part 720 and oscillates the diaphragm 722. It is preferable to form a diameter of the sound hole 727 as same as that of the opening part 720. The diameter of the sound hole 727 can be formed slightly smaller than that of the opening 720 in consideration of easiness of assembling (slight misalignment of an axis will be allowed). A small piercing hole 722a for pressure adjustment is formed at a peripheral rim of the diaphragm 722. This piercing hole 722a connects the internal space 726 (this internal space 726 forms a back air chamber for the condenser microphone element 712. The “back air chamber” indicates a space in the back of the diaphragm viewed from irradiating side of the sound waves) via the sound hole 727 to outside and makes the pressure in the internal space 726 in the package 711 same as outside pressure. The piercing hole 722a for pressure adjustment hardly passes the sound waves. A terminal 723 of the diaphragm 722 and a terminal 725 of the back plate 724 are formed on an upper surface of the condenser microphone element 712 away from the back plate 724.

The condenser microphone element 714 is formed as same as the condenser microphone element 712. That is, the condenser microphone element 714 is formed by arranging a diaphragm 734 and a back plate 736 opposing to each other with an arbitral space between them inside the opening part 732 of the substrate 730 made of silicon and the like. Plurality of piercing holes 736a are formed on the back plate 736, and sound waves generated by oscillation of the diaphragm 722 pierces these piercing holes 736a and transmitted to the internal space 726, and a diaphragm 734 is oscillated. A small piercing hole 734a for pressure adjustment is formed at a peripheral rim of the diaphragm 734. This piercing hole 734a makes the pressure in the internal space 733 (this internal space 733 forms a back air chamber for the condenser microphone element 714.) of the opening part 732 same as the pressure of the internal space 726 in the package 711. Therefore, the internal space 733 of the condenser microphone element 714 is connected to outside via the piercing hole 734a for pressure adjustment, the piercing hole 736a of the back plate 736, the internal space 726 of the package 711, the piercing hole 724a of the back plate 724 of the condenser microphone element 712, the piercing hole 722a for pressure adjustment of the diaphragm 722, the opening part 720 and the sound hole 727 and is adjusted to the same pressure as the outside pressure. The piercing hole 734a for pressure adjustment hardly passes sound waves. A terminal 735 of the diaphragm 734 and a terminal 737 of the back plate 736 are formed on an upper surface of the condenser microphone element 714 away from the back plate 736. Each of the terminals 723, 725, 735 and 737 of the condenser microphone elements 712 and 714 is respectively connected to corresponding terminals 716a, 716b, 716c and 716d with signal lines 715, 717, 719 and 721.

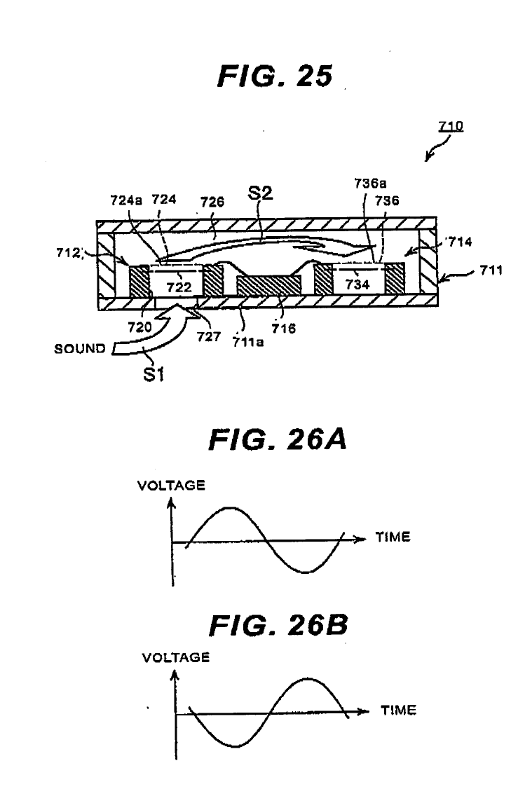

An operation of the condenser microphone 710 with the above-described structure will be explained. FIG. 25 is a pattern diagram showing an operation of the condenser microphone 710 when sound waves are irradiated from outside to the condenser microphone 710. At this time, the sound waves S1 from outside is irradiated from the sound hole 727 of the bottom plate 711a of the package and pass through the opening part 720 of the condenser microphone element 712 and oscillate the diaphragm 722. When the diaphragm oscillates, the sound waves S2 are generated on the back of the diaphragm 722 by the oscillation. This sound waves S2 pass through the piercing hole 724a of the back plate 724 and the piercing hole 736a of the back plate 736 of the condenser microphone element 714 and oscillate the diaphragm 734. FIG. 26A is a graph showing a waveform of output signal of the condenser microphone element 712, and FIG. 26B is a graph showing a waveform of output signal of the condenser microphone element 714 according to the operation shown in FIG. 25. Since irradiating directions of the sound waves of the condenser microphone elements 712 and 714 are opposite to each other, output waveforms will be in different phases. Therefore, when both output signals are subtracted to each other, output with more increased amplitude than the individual output signal can be obtained.

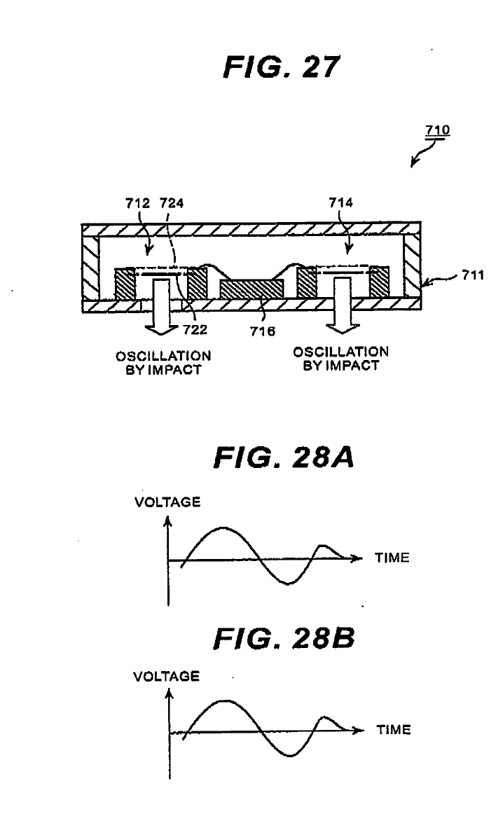

FIG. 27 is a pattern diagram showing an operation of the condenser microphone 710 when an impact is given to the condenser microphone 710 in FIG. 24 from outside. At this time, the same impact is given to the diaphragms 722 and 734 of the condenser microphone elements 712 and 714, and the diaphragms 722 and 734 displace in the same direction with inertia by the impact. FIG. 28A is a graph showing a waveform of output signal of the condenser microphone element 712, and FIG. 28B is a graph showing a waveform of output signal of the condenser microphone element 714 according to the operation shown in FIG. 27. The diaphragms 712 and 714 of both condenser elements displace in the same direction with inertia by the impact. Therefore, when subtraction of both output signals of the first and second condenser elements is performed, output with more decreased amplitude than the individual output signal can be obtained.

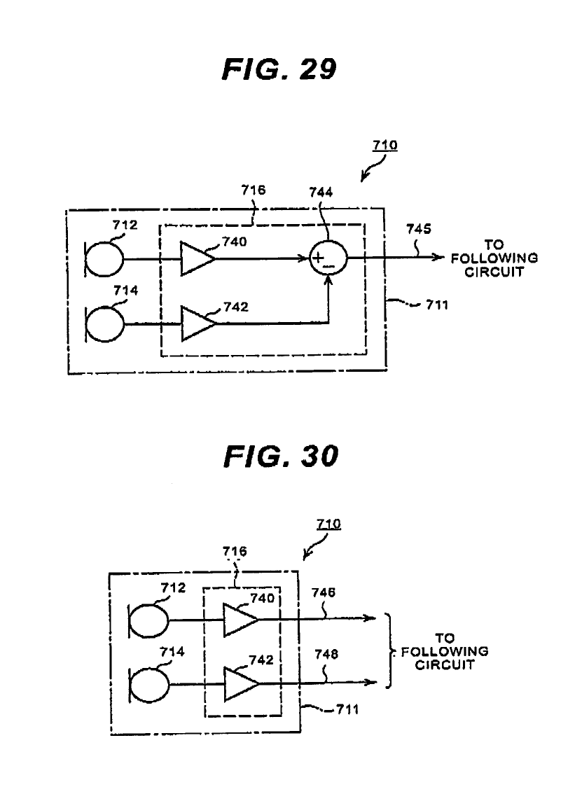

FIG. 29 is a schematic circuit diagram of the condenser microphone 710 according to the sixth embodiment of the present invention, inside a dash-dotted line is components in the package 11, and components inside a dotted rectangle are the LSI 716 for impedance conversion and calculation. Output signals of the condenser microphone element 712 are performed impedance conversion and gain adjustment by the impedance converter and a gain adjuster 740. Output signals of the condenser microphone element 714 are performed impedance conversion and gain adjustment by the impedance converter and a gain adjuster 742. Output signals of the impedance converters and the gain adjusters 740 and 742 are subtracted to each other by a subtraction device 744. The output signals of the subtraction device 744 are output from the package 711 by output signal line 745 as output signals (microphone output) of the condenser microphone 710.

Because the capacity of the internal space 726 of the package 711 forming the back air chamber of the condenser microphone element 712 is different from the capacity of the internal space 733 of the opening part 732 forming the back air chamber of the condenser microphone element 714 (the internal space 726>the internal space 733), sensitivities of the condenser microphone elements 712 and 714 are also different from each other (i.e., the sensitivity of the condenser microphone element 712 will be higher because the diaphragm with a larger internal space has greater tendency to displace). Signal gain is adjusted with the impedance converters and the gain adjusters 740 and 742 so that the output signal of the subtraction device 744 becomes the minimum value to the impact. By that, Output signal level of the subtraction device 744 becomes small to an impact and large to a sound. Therefore, high sensitivity can be kept regarding to a sound, and sensitivity to an impact becomes lower, and generation of an impact sound can be restrained when the impact is given to the condenser microphone 710.

The condenser microphone according to a seventh embodiment of the present invention will be explained. In the seventh embodiment of the present invention, output signals of both of the condenser microphone elements are taken out from the package of the condenser microphone as a balanced output. A mechanical structure of the package is same as that in FIG. 24. FIG. 30 is a schematic circuit diagram of the condenser microphone 710 according to a seventh embodiment of the present invention. In FIG. 30, the same reference numbers represent the same components in FIG. 29. Aside a dash-dotted line is components in the package 11, and components inside a dotted rectangle are the LSI 716 for impedance conversion and calculation. Output signals of the condenser microphone element 712 are performed impedance conversion and gain adjustment by the impedance converter and the gain adjuster 740. Output signals of the condenser microphone element 714 are performed impedance conversion and gain adjustment by the impedance converter and the gain adjuster 742. The output signals of the impedance converters and the gain adjusters 740 and 742 are output from the package 711 by output signal lines 746 and 748 as balanced outputs of the condenser microphone 710. These balanced outputs are used as microphone outputs subtracted to each other at a following circuit. By that, signals with a good S/N ratio can be obtained by removing the noise by subtraction at the following circuit even though a noise enters on the output signals 746 and 748 of the balanced outputs. The impedance conversion and the gain adjustment by the gain adjusters 740 and 742 are same as those in the sixth embodiment.

Although the sound hole in FIG. 24 was in a circular shape in the sixth and the seventh embodiments. It can be in other shape. For example, when the opening part 720 of the substrate 718 of the condenser microphone element 712 is in a square shape, the sound hole 727 can be formed in a square shape corresponding to that. Moreover, although the diaphragms 722 and 734 are positioned below the back plates 724 and 736 in the condenser microphone elements 712 and 714 according to the sixth and the seventh embodiments, the diaphragms 722 and 734 can be positioned above the back plates can be positioned at lower part. Furthermore, although the condenser microphone elements 712 and 714 are formed by the MEMS elements as shown in FIG. 24, they can be formed by assembling individual parts.

Moreover, the condenser microphone (element) in the first to fifth embodiments may be used in the sixth and seventh embodiments. For example, the condenser microphone 14 according to the first embodiment can be used as the condenser microphone elements 712 and 714 in the sixth and seventh embodiments by adjusting sizes of the opening part 720.

The present invention has been described in connection with the preferred embodiments. The invention is not limited only to the above embodiments. It is apparent that various modifications, improvements, combinations, and the like can be made by those skilled in the art.

What are claimed are:

1. A condenser microphone, comprising:
a first condenser type element having a diaphragm and a back plate which opposes to each other via a space;
a second condenser type element having a diaphragm and a back plate which opposes to each other via a space;
a subtraction device that subtracts a terminal voltage of the second condenser type element from a terminal voltage of the first condenser type element; and
an output device that outputs an output of the subtraction device as a microphone output, and wherein same planes of the first and the second condenser type elements are arranged in a same direction, and
the second condenser type element has a larger ratio of an amount of sound waves picked up on a surface of the diaphragm to an amount of sound waves passing around and picked up on a back of the diaphragm than that of the first condenser type element.

2. The condenser microphone according to claim 1, wherein the subtraction device subtracts the terminal voltage of the second condenser type element from the terminal voltage of the first condenser type element after making the terminal voltage of the second condenser type element pass through a low-pass filter.

3. The condenser microphone according to claim 1, wherein
each of the first and the second condenser type elements comprises a base part having a back cavity, one side of which is covered by the diaphragm of the first or the second condenser type element and another side of which is closed,
each of the diaphragms of the first and the second condenser type elements is supported by one surface of each base part and has a pierced hole on a peripheral rim to pass a sound wave to each back cavity,
each of the back plates of the first and the second condenser type elements has a pierced hole thorough which the sound wave passes on its surface and is supported by one surface of each base part to be arranged above each diaphragm via the space,
the back cavity of the first condenser type element has an audio resistance formed with a step formed in an intermediate part in an axis direction to make an inner diameter of a part close to the diaphragm larger than a part far from the diaphragm, and
the back cavity of the second condenser type element has an audio resistance that is smaller than the audio resistance formed in the back cavity of the first condenser type element or has no audio resistance.

4. The condenser microphone according to claim 1, wherein the diaphragm of the second condenser type element has a pierced hole to make a part of sound waves impacted on a surface of the diaphragm pass through to a back of the diaphragm, whereas the diaphragm of the first condenser type element has no pierced hole on a surface.

5. The condenser microphone according to claim 1, wherein a diameter of a main part of the back cavity of the first condenser type element is smaller than a diameter of a main part of the back cavity of the first condenser type element, and sizes of other parts are same.

6. The condenser microphone according to claim 1, wherein difference of sensitivities to an impact sound between the diaphragms of the first and the second condenser type elements is within 3 dB or preferably within 1 dB.

7. The condenser microphone according to claim 1, wherein the first and the second condenser type elements are formed of micro electro mechanical systems (MEMS) devices.

8. A condenser microphone, comprising:
a first condenser type element having a diaphragm and a back plate which oppose to each other via a space;
a second condenser type element having a diaphragm and a back plate which oppose to each other via a space and a same property as the first condenser element;
a first wiring that electrically connects the diaphragm of the first condenser type element with the diaphragm of the second condenser type element; and
a second wiring that electrically connects the back plate of the first condenser type element with the back plate of the second condenser type element,
wherein the first and the second condenser type elements are configured by facing the diaphragms or the back plates.

9. The condenser microphone according to claim 8, wherein
each of the first and the second condenser type elements comprises a substrate having a back cavity, one side of which is covered by the diaphragm of the first or the second condenser type element,
each of the back plates of the first and the second condenser type elements has a pierced hole to pass a sound wave from outside,
each of the diaphragms of the first and the second condenser type elements has a pierced hole thorough which connects the back cavity to an open air via the pierced hole of the back cavity, and
each of the back cavity of the first and the second condenser type elements has an audio resistance formed with a step formed in an intermediate part in an axis direction to make an inner diameter of a part close to the diaphragm larger than a part far from the diaphragm.

10. The condenser microphone according to claim 8, wherein the first and the second condenser type elements are formed of micro electro mechanical systems (MEMS) devices.

11. A condenser microphone, comprising:
a first condenser type element having a diaphragm and a back plate which oppose to each other via a space;
a second condenser type element having a diaphragm and sharing the back plate with the first condenser type element, the diaphragm and the shared back plate opposing to each other via a space; and
a wiring that electrically connects the diaphragm of the first condenser type element with the diaphragm of the second condenser type element.

12. The condenser microphone according to claim 11, wherein the first and the second condenser type elements are formed of micro electro mechanical systems (MEMS) devices.

13. A condenser microphone, comprising:
a first condenser type element having a diaphragm and a back plate which oppose to each other via a space;
a second condenser type element having a diaphragm and a back plate which oppose to each other via a space and a same property as the first condenser element;
a package in which the first and the second condensers are placed with facing same planes in a same direction; and
an audio hole that is formed at a position of the package corresponding to a sound wave irradiating surface of the first condenser type element, takes in a sound wave from outside and is acoustically closed by the first condenser type element,
wherein a sound wave is taken into the package from the audio hole and oscillates the diaphragm of the first condenser type element, and a sound wave generated by the oscillation of the diaphragm of the first condenser type element is transmitted inside a space of the package and oscillates the diaphragm of the second condenser type element.

14. The condenser microphone according to claim 13, further comprising:
impedance converters in the package for the first and the second condenser type elements; and
a subtraction device that subtracts outputs signals of the impedance converters with each other and outputs the subtracted signal to an external device.

15. The condenser microphone according to claim 13, further comprising:
impedance converters in the package for the first and the second condenser type elements and individually output the converted signals to an external device.

16. The condenser microphone according to claim 13, wherein the first and the second condenser type elements are formed of micro electro mechanical systems (MEMS) devices.
